(19) United States
(12) Patent Application Publication
(10) Pub. No.: US 2026/0059484 A1
(43) Pub. Date: Feb. 26, 2026

(54) SIDELINK POSITIONING TECHNIQUE

(71) Applicant: Telefonaktiebolaget LM Ericsson (publ), Stockholm (SE)

(72) Inventors: Min WANG, Luleå (SE); Ritesh SHREEVASTAV, Upplands Väsby (SE); Iana SIOMINA, Täby (SE)

(21) Appl. No.: 19/482,930

(22) PCT Filed: May 13, 2024
(86) PCT No.: PCT/EP2024/063098

§ 371 Date: Nov. 10, 2025

Related U.S. Application Data
(60) Provisional application No. 63/465,648, filed on May 11, 2023.

(51) Int. Cl. H04W 64/00; H04B 7/06; H04W 36/00; H04W 72/25

(52) U.S. Cl. CPC H04W 64/00; H04B 7/06964; H04W 36/0072; H04W 72/25

(57) ABSTRACT

A technique for handling a sidelink, SL, positioning procedure is described. As to a method aspect of the technique, information indicative of a distortion of a radio link of at least one radio device among radio devices involved in the SL positioning procedure is obtained. One or more actions that handle the distortion based on the obtained information are performed.

### TECHNICAL FIELD

The present disclosure relates to sidelink as a device-to-device communication technique for positioning a radio device. More specifically, and without limitation, methods and devices are provided for handling a distortion on a radio link used for allocating radio resources for the sidelink positioning.

### BACKGROUND

The Third Generation Partnership Project (3GPP) defined sidelinks (SLs) in Release 12 as an adaptation of the 4G Long Term Evolution (LTE) radio access technology (RAT) for direct communication between two radio devices, also referred to as user equipment (UE), without going through a base station. Such device-to-device (D2D) communications through SLs are also referred to as proximity service (ProSe) and can be used for Public Safety and commercial communications. such as vehicle-to-everything (V2X) scenarios.

SL communication is also an integral part of 3GPP New Radio (NR) as a 5G RAT. One of the key use cases for SL is to support positioning services, which can be used for a variety of applications such as location-based services, indoor navigation, and emergency response. Noteworthy, SL positioning can contribute in scenarios where satellite-based or cellular positioning may not be available or reliable.

SL positioning allows radio devices to determine their location by exchanging reference signals with other nearby devices. For example, the radio devices can measure a time difference of arrival (TDoA) or an angle of arrival (AoA) of signals received from other devices and use this information to estimate their position. These SL positioning techniques are known as time-based positioning and angle-based positioning, respectively. Alternatively or in addition, in SL positioning, the radio devices can exchange positioning information about their position with other radio devices, which improves the accuracy of the positioning. The positioning accuracy can be improved by using multiple devices for the measurements and by signal processing to estimate the position.

Even though the reference signals and positioning information are exchanged through SLs without direct involvement of a node of the radio access network (RAN), the RAN is still in charge of allocating radio resource for the SL positioning (i.e., the SL positioning resources) in order to orchestrate the radio devices using the SL channels so as to reduce interference, minimizing transmit collisions, maximize throughput, and prioritize data traffic. However, as a consequence, a disturbance in the radio link between a radio device involved in the SL positioning and the RAN can lead to a failure of the SL positioning service.

### SUMMARY

Accordingly, there is a need for a sidelink (SL) positioning technique that is more deterministic or robust in the presence of disturbances in the radio link between radio devices involved in the SL positioning and a radio access network (RAN) allocating the SL positioning resources.

As to a first method aspect, a method of handling a sidelink (SL) positioning procedure is provided. The method comprises or initiates a step of obtaining information indicative of a distortion of a radio link of at least one radio device among radio devices involved in the SL positioning procedure. The method further comprises or initiates a step of performing one or more actions that handle the distortion based on the obtained information.

The first method aspect may be implemented alone or in combination with any one of the dependent claims, particularly the claims 1 to 29.

The first method aspect may be performed at or embodied by a network node (e.g., of a radio access network, RAN). The RAN, e.g., the network node, may serve (e.g., provide radio access to) the at least one radio device and/or the target radio device and/or the one or more assisting radio devices.

As to a second method aspect, a method of handling a sidelink (SL) positioning procedure is provided. The method comprises or initiates a step of obtaining information indicative of a distortion of a radio link of at least one radio device among radio devices involved in the SL positioning procedure. The method further comprises or initiates a step of performing one or more actions that handle the distortion based on the obtained information.

The second method aspect may be implemented alone or in combination with any one of the dependent claims, particularly the embodiments 1 to 29.

The second method aspect may be performed at or embodied by a target radio device of the SL positioning procedure. The SL positioning procedure may determine or track the position of the target radio device, e.g., the absolute position of the target radio device and/or the relative position of the target radio device relative to one or more of the radio devices involved in the SL positioning procedure.

The second method aspect may further comprise any feature and/or any step disclosed in the context of the first method aspect, or a feature and/or step corresponding thereto, e.g., a receiver counterpart to a transmitter feature or step.

As to a third method aspect, a method of handling a sidelink (SL) positioning procedure is provided. The method comprises or initiates a step of obtaining information indicative of a distortion of a radio link of at least one radio device among radio devices involved in the SL positioning procedure. The method further comprises or initiates a step of performing one or more actions that handle the distortion based on the obtained information.

The third method aspect may be implemented alone or in combination with any one of the dependent claims, particularly the embodiments 1 to 29.

The third method aspect may be performed at or embodied by any one of the one or more assistance radio devices of the SL positioning procedure. The SL positioning procedure may determine or track the position of a target radio device based on reference signals and/or measurement results exchanged on a SL between the assistance radio device performing the third method aspect and the target radio device.

The third method aspect may further comprise any feature and/or any step disclosed in the context of the first and/or second method aspect, or a feature and/or step corresponding thereto, e.g., a network counterpart to a radio device feature or step or a transmitter-receiver correspondence.

As to a fourth method aspect, a method of handling a sidelink (SL) positioning procedure is provided. The method comprises or initiates a step of obtaining information indicative of a distortion of a radio link of at least one radio device among radio devices involved in the SL positioning procedure. The method further comprises or initiates a step of performing one or more actions that handle the distortion based on the obtained information.

The fourth method aspect may be implemented alone or in combination with any one of the dependent claims, particularly the embodiments 1 to 29.

The fourth method aspect may be performed at or embodied by any one of the one or more positioning server of the SL positioning procedure. The SL positioning procedure may determine or track the position of a target radio device based on reference signals and/or measurement results exchanged on a SL between the assistance radio device performing the fourth method aspect and the target radio device.

The fourth method aspect may further comprise any feature and/or any step disclosed in the context of the first, second and/or third method aspect, or a feature and/or step corresponding thereto, e.g., a network counterpart to a radio device feature or step or a transmitter-receiver correspondence.

At least some method embodiments of any method aspect can provide a mechanism to avoid interruption for sidelink (SL) positioning in case of the disturbance, e.g., in case of a handover (HO), a radio link failure (RLF), or an RRC re-establishment at the at least one radio device.

Without limitation, for example in a 3GPP implementation, any “radio device” may be a user equipment (UE). Any one of the method aspects may be embodied by a method of SL positioning, e.g. according to an application layer indicator and/or a desired QoS.

As to another aspect, a computer program product is provided. The computer program product comprises program code portions for performing the steps of any one of the method aspects when the computer program product is executed on one or more computing devices. The computer program product may be stored on a computer-readable recording medium.

As to a first device aspect, a network node is provided. The network node comprises memory operable to store instructions and processing circuitry operable to execute the instructions, such that the network node is operable to obtain information indicative of a distortion of a radio link of at least one radio device among radio devices involved in a SL positioning procedure, and to perform one or more actions that handle the distortion based on the obtained information.

As to a second device aspect, a target radio device is provided. The target radio device comprises memory operable to store instructions and processing circuitry operable to execute the instructions, such that the target radio device is operable to obtain information indicative of a distortion of a radio link of at least one radio device among radio devices involved in a SL positioning procedure, and to perform one or more actions that handle the distortion based on the obtained information.

As to a third device aspect, a assisting (e.g. reference) radio device is provided. The assisting (e.g. reference) radio device comprises memory operable to store instructions and processing circuitry operable to execute the instructions, such that the assisting (e.g. reference) radio device is operable to obtain information indicative of a distortion of a radio link of at least one radio device among radio devices involved in a SL positioning procedure, and to perform one or more actions that handle the distortion based on the obtained information.

As to a fourth device aspect, a positioning server is provided. The positioning server comprises memory operable to store instructions and processing circuitry operable to execute the instructions, such that the positioning server is operable to obtain information indicative of a distortion of a radio link of at least one radio device among radio devices involved in a SL positioning procedure, and to perform one or more actions that handle the distortion based on the obtained information.

### BRIEF DESCRIPTION OF THE DRAWINGS

Further details of embodiments of the technique are described with reference to the enclosed drawings, wherein:

FIG. 1 shows a schematic block diagram of an embodiment of a device for handling (e.g., a distortion in) a SL positioning procedure according to a first device aspect;

FIG. 2 shows a schematic block diagram of an embodiment of a device for handling (e.g., a distortion in) a SL positioning procedure according to a second device aspect;

FIG. 3 shows a schematic block diagram of an embodiment of a device for handling (e.g., a distortion in) a SL positioning procedure according to a third device aspect;

FIG. 4 shows a schematic block diagram of an embodiment of a device for handling (e.g., a distortion in) a SL positioning procedure according to a fourth device aspect;

FIG. 5 shows a flowchart for a method of handling (e.g., a distortion in) a SL positioning procedure, which method may be implementable by the device of FIG. 1;

FIG. 6 shows a flowchart for a method of handling (e.g., a distortion in) a SL positioning procedure, which method may be implementable by the device of FIG. 2;

FIG. 7 shows a flowchart for a method of handling (e.g., a distortion in) a SL positioning procedure, which method may be implementable by the device of FIG. 3;

FIG. 8 shows a flowchart for a method of handling (e.g., a distortion in) a SL positioning procedure, which method may be implementable by the device of FIG. 4;

FIG. 9A schematically illustrates a first example of a radio network comprising embodiments of the devices of FIGS. 1, 2, 3, and 4 in complete coverage for performing the methods of FIGS. 5, 6, 7, and 8, respectively;

FIG. 9B schematically illustrates a second example of a radio network comprising embodiments of the devices of FIGS. 1, 2, 3, and 4 in partial coverage for performing the methods of FIGS. 5, 6, 7, and 8, respectively;

FIG. 9C schematically illustrates a third example of a radio network comprising embodiments of the devices of FIGS. 1, 2, 3, and 4 out of coverage for performing the methods of FIGS. 5, 6, 7, and 8, respectively;

FIGS. 10A and 10B schematically illustrate embodiments of the devices of FIGS. 2 and 3 in SL communication for performing the SL positioning procedure;

FIG. 11 schematically illustrates a fourth example of a radio network comprising embodiments of the devices of FIGS. 1, 2, 3, and 4 for performing the methods of FIGS. 5, 6, 7, and 8, respectively;

FIG. 12 shows a flowchart of an example procedure for performing the SL communication, which may be implemented at any embodiment of the devices of FIG. 2 or 3 for performing the methods of FIG. 6 or 7, respectively;

FIGS. 13A and 13B show an example timeline for performing the SL communication, which may be implemented at any embodiment of the devices of FIG. 2 or 3 for performing the methods of FIG. 6 or 7, respectively;

FIG. 14 schematically illustrates a fifth example of a radio network comprising embodiments of the devices of FIGS. 1, 2, 3, and 4 for performing the methods of FIGS. 5, 6, 7, and 8, respectively;

FIG. 15A schematically illustrates a first example of a radio protocol event at a target radio device, which event causes a distortion of a RAN connection;

FIG. 15B schematically illustrates a second example of a radio protocol event at an assisting radio device, which event causes a distortion of a RAN connection;

FIG. 16 schematically illustrates a first signaling diagram resulting from embodiments of the devices of FIGS. 1, 2, and 3 performing the methods of FIGS. 5, 6, and 7, respectively, in SL radio communication and backhaul communication;

FIG. 17 schematically illustrates a second signaling diagram resulting from embodiments of the devices of FIGS. 2 and 3 performing the methods of FIGS. 6 and 7, respectively, in SL radio communication and backhaul communication;

FIG. 18 shows a schematic block diagram of a network node embodying the device of FIG. 1;

FIG. 19 shows a schematic block diagram of a radio device involved in the SL positioning procedure and embodying the device of FIG. 2 or 3;

FIG. 20 shows a schematic block diagram of a positioning server embodying the device of FIG. 4;

FIG. 21 schematically illustrates an example telecommunication network connected via an intermediate network to a host computer;

FIG. 22 shows a generalized block diagram of a host computer communicating via a base station or radio device functioning as a gateway with a user equipment over a partially wireless connection; and

FIGS. 23 and 24 show flowcharts for methods implemented in a communication system including a host computer, a base station or radio device functioning as a gateway and a user equipment.

### DETAILED DESCRIPTION

In the following description, for purposes of explanation and not limitation, specific details are set forth, such as a specific network environment in order to provide a thorough understanding of the technique disclosed herein. It will be apparent to one skilled in the art that the technique may be practiced in other embodiments that depart from these specific details. Moreover, while the following embodiments are primarily described for a New Radio (NR) or 5G implementation, it is readily apparent that the technique described herein may also be implemented for any other radio communication technique, including a Wireless Local Area Network (WLAN) implementation according to the standard family IEEE 802.11, 3GPP LTE (e.g., LTE-Advanced or a related radio access technique such as MulteFire), for Bluetooth according to the Bluetooth Special Interest Group (SIG), particularly Bluetooth Low Energy, Bluetooth Mesh Networking and Bluetooth broadcasting, for Z-Wave according to the Z-Wave Alliance or for ZigBee based on IEEE 802.15.4.

Moreover, those skilled in the art will appreciate that the functions, steps, units and modules explained herein may be implemented using software functioning in conjunction with a programmed microprocessor, an Application Specific Integrated Circuit (ASIC), a Field Programmable Gate Array (FPGA), a Digital Signal Processor (DSP) or a general purpose computer, e.g., including an Advanced RISC Machine (ARM). It will also be appreciated that, while the following embodiments are primarily described in context with methods and devices, the invention may also be embodied in a computer program product as well as in a system comprising at least one computer processor and memory coupled to the at least one processor, wherein the memory is encoded with one or more programs that may perform the functions and steps or implement the units and modules disclosed herein.

An aspect relates to a method of handling a sidelink (SL) positioning procedure. The method may comprise or initiate a step of obtaining (e.g., receiving or measuring) information indicative of a distortion of a radio link of at least one radio device among radio devices involved in the SL positioning procedure. Alternatively or in addition, the method may comprise or initiate a step of performing one or more actions that handle the distortion based on obtained information (e.g., the obtained information).

The method may be implemented as a method of handling the distortion and/or as a method of performing the SL positioning procedure.

The SL positioning procedure may comprise a SL positioning session (e.g., a step of discovering the radio devices involved in the SL positioning procedure and/or a step of establishing and/or releasing the SL positioning session). The SL positioning session may involve the at least one radio device.

The one or more actions may be performed during the SL positioning procedure (e.g., during the SL positioning session).

The radio devices involved in the SL positioning procedure may comprise only radio devices involved in the same SL positioning procedure (e.g., participants of the same positioning session). Alternatively or in addition, the radio devices involved in the SL positioning procedure may comprise only radio devices served by the same network node of a radio access network (RAN).

The SL positioning procedure may determine the position of a target radio device. The at least one radio device may be, or may comprise, the target radio device. Alternatively or in addition, the at least one radio device may be, or may comprise, one or more assisting radio devices that assist in the SL positioning procedure.

The information may be indicative that the at least one radio device (e.g., the target radio device) is experiencing the distortion (e.g., a radio problem), e.g., associated with a radio link failure (RLF), an RRC reestablishment, or a handover.

The distortion may be a current distortion or a future distortion.

The distortion may be associated with a radio link failure (RLF), a radio resource control (RRC) reestablishment, and/or a handover (HO).

In an embodiment, the distortion may be associated with a radio protocol event at the at least one radio device. For example, the radio protocol event may include a handover (HO) of the at least one radio device. Alternatively or in addition, the radio protocol event may include a cell change of the at least one radio device. Alternatively or in addition, the radio protocol event may include a radio resource control (RRC) connection establishment or an RRC connection re-establishment of the indicated radio link. Alternatively or in addition, the radio protocol event may include an RRC configuration or an RRC reconfiguration of the indicated radio link. Alternatively or in addition, the radio protocol event may include the at least one radio device triggering a HO in the RRC connected mode. Alternatively or in addition, the radio protocol event may include a link quality of the indicated radio link being less than a predefined link quality threshold. Alternatively or in addition, the radio protocol event may include a RAN connection failure. Alternatively or in addition, the radio protocol event may include a radio link failure (RLF) of the indicated radio link. Alternatively or in addition, the radio protocol event may include a beam failure detection or beam failure recovery of the indicated radio link. Alternatively or in addition, the radio protocol event may include a running 3GPP timer T310. Alternatively or in addition, the radio protocol event may include a running 3GPP timer T311. Alternatively or in addition, the radio protocol event may include a running 3GPP timer T301. Alternatively or in addition, the radio protocol event may include a running 3GPP timer T304.

The link quality and the link quality threshold may be defined in terms of at least one of: a reference signal received power (RSRP), a reference signal received quality (RSRQ), and a received signal strength indicator (RSSI). Herein, “predefined” may encompass at least one of specified in a technical standard, configured (e.g., by the RAN such as the serving network node), and encoded (e.g., hard-coded) at the radio device.

In an embodiment, the obtaining of the information indicative of the distortion may comprise detecting the distortion by the at least one radio device.

In an embodiment, the performing of the action may comprise using a dedicated resource pool or an exceptional resource pool.

In an embodiment, the performing of the action may comprise the at least one radio device using an SL resource allocation mode. The at least one radio device may autonomously select SL resources from the one or multiple TX resource pools and/or the one or multiple RX resource pools, e.g. based on a random selection using an exceptional pool of concerned SL frequency, to perform sidelink transmission and reception.

In an embodiment, the distortion may comprise a handover (HO) of the at least one radio device and/or the information indicative of the distortion comprises a handover command. Alternatively or in addition, the performing of the action may comprise the at least one radio device performing a SL transmission and/or SL reception based on a reception resource pool of a target cell of the HO or a reception resource pool of a target cell as provided in the handover command.

In an embodiment, allocated SL positioning resources may include one or multiple TX resource pools on a SL carrier in a target cell of a HO and/or one or multiple RX resource pools on a SL carrier. Alternatively or in addition, allocated SL positioning resources may include one or multiple TX resource pools on a SL carrier in a target cell of a HO and/or one or multiple RX resource pools on a SL carrier in a target cell of a HO.

In an embodiment, allocated SL positioning resources in a target cell of a HO may belong to a dedicated SL resource pool for SL positioning. Alternatively or in addition, allocated SL positioning resources in a target cell of a HO may belong to a shared SL resource pool shared by SL positioning and other SL communication. Alternatively or in addition, allocated SL positioning resources in a target cell of a HO may belong to an exceptional SL resource pool which is used by the at least one radio device for SL positioning if the distortion includes detection of RLF, RRC reestablishment, or HO.

In an embodiment, performing the one or more actions may comprise transmitting or receiving a HO command providing a SL positioning resource configuration to the at least one radio device. Among positioning resource pools configured in a target cell, there may be at least one positioning resource pool which is dedicated for SL positioning purpose.

In an embodiment, the obtaining of the information indicative of the distortion may comprise receiving a radio resource control (RRC) reconfiguration message for a reconfiguration with synchronization, the reconfiguration configuring the at least one radio device with a SL positioning reference signal (PRS) reception pool.

The radio devices involved in the SL positioning procedure may comprise a target radio device which position is determined by the SL positioning procedure. Alternatively or in addition, the radio devices involved in the SL positioning procedure may comprise one or more assisting radio devices which assist the target radio device in the SL positioning procedure.

In an embodiment, the method may be performed by a network node serving the at least one radio device. Alternatively or in addition, the method may be performed by the target radio device. Alternatively or in addition, the method may be performed by the one or more assisting radio devices. Alternatively or in addition, the method may be performed by a positioning server, optionally a location management function, LMF.

In an embodiment, the target radio device does not select a radio device which is experiencing at least one of RLF, RRC reestablishment and handover as assisting radio device.

The one or more assisting radio devices may comprise one or more reference radio devices (also referred to as anchor radio devices).

The target radio device and the one or more assisting radio devices may exchange reference signals (RSs) according to the SL positioning procedure. For example, the radio devices may measure a time difference of arrival (TDoA) or an angle of arrival (AoA) of reference signals received from each other or from other radio devices and use this information to estimate at least the position of the target radio device. Alternatively or in addition, the radio devices may exchange positioning information about their position with other radio devices, which improves the accuracy of the positioning. The positioning accuracy can be improved by using multiple devices for the measurements and by signal processing to estimate the position.

In an embodiment, the indicated radio link may be used for allocating SL positioning resources to the at least one radio device prior to the distortion. The allocated SL positioning resources may include one or multiple TX resource pools on a SL carrier and/or one or multiple RX resource pools on a SL carrier. Alternatively or in addition, the information may comprise a SL positioning resource pool to be used during handover.

Allocating the SL positioning resources may encompass at least one of: (e.g., dynamically) scheduling the SL positioning resources (e.g., according to mode 1), configuring a grant (e.g., according to type 1) for the SL positioning resources, and activating or deactivating a configured grant (e.g., according to type 2) for the SL positioning resources.

The at least one radio device may be transmitting or receiving SL reference signals for the SL positioning procedure.

The involvement of the at least one radio device in the SL positioning procedure may comprise transmitting or receiving reference signals for the SL positioning procedure. Alternatively or in addition, the reference signal for the SL positioning procedure may comprise SL positioning reference signals (SL PRS) and/or SL sounding reference signals (SL SRS).

Alternatively or in addition, the at least one radio device being involved in the SL positioning procedure may mean that the at least one radio device has ongoing allocated SL positioning resources in the SL positioning procedure.

In an embodiment, the indicated radio link may be used for allocating SL positioning resources to the at least one radio device prior to the distortion. The at least one radio device may be transmitting and/or receiving SL reference signals for the SL positioning procedure using the allocated SL positioning resources.

The indicated radio link may be a radio link between a radio access network (RAN) and the at least one radio device. The RAN may comprise at least one network node involved in the SL positioning procedure.

In an embodiment, the at least one radio device may autonomously select sidelink resources from the one or multiple TX resource pools, and/or from the one or multiple RX resource pools, based on a channel sensing mechanism.

In an embodiment, during RLF detection and/or RLF recovery and/or RRC re-establishment and/or handover (HO), the at least one radio device may use an SL resource allocation mode. The at least one radio device may autonomously select SL resources from the one or multiple TX resource pools and/or the one or multiple RX resource pools, based on random selection using an exceptional pool of concerned SL frequency, to perform sidelink transmission and reception.

In an embodiment, the indicated radio link may be a radio link, optionally a downlink or an uplink, between the at least one radio device and a network node serving the at least one radio device and/or a Uu interface at the at least one radio device.

The indicated radio link that is subject to the distortion may be at the same at least one radio device that is involved in the SL positioning procedure. Alternatively or in addition, the indicated radio link that is subject to the distortion may be different from a SL interface (e.g., a PC5 interface) used by the at least one radio device for the SL positioning procedure.

The indicated radio link may be a downlink (DL), e.g. a physical DL control channel (PDCCH) carrying downlink control information (DCI) or a physical DL shared channel (PDSCH) carrying a MAC CE or RRC signaling for the allocation of the SL positioning resources.

The distortion (e.g., a link failure) may occur on the uplink, e.g. due to a radio link control (RLC) retransmission time out and/or reaching a maximum number of RLC UL retransmissions and/or reaching a maximum number of random access channel (RACH) preamble (also: random access preamble, RAP) transmission attempts.

In an embodiment, the performing of the one or more actions may comprise receiving at the at least one radio device from a target network node, or transmitting from a target network node to the at least one radio device, a handover command (HO command) based on the obtained information, optionally the HO command being indicative of a configuration of SL positioning resources allocated to the at least one radio device.

In an embodiment, the obtaining of the information may comprise receiving a control message indicative of the distortion of the radio link of the at least one radio device.

In an embodiment, the method may further comprise or initiate a step of receiving a message in response to the performed one or more actions. E.g., the message may be received from (e.g., among) the at least one radio device or a network node serving the at least one radio device. Alternatively or in addition, the method may further comprise or initiate transmitting a message in response to the performed one or more actions. E.g., the message may be transmitted from the at least one radio device or a network node serving the at least one radio device.

The received message may comprise a handover (HO) command. The HO command may be indicative of (e.g., a configuration of) SL positioning resource in a target cell of the HO and/or allocated by the target network node.

The distortion may be associated with a context fetch procedure or a RRC resume procedure for the at least one radio device in the RRC inactive state and/or the information may be obtained over an Xn interface and/or the obtaining may include receiving an RRC resume request indicative of at least one of the ongoing SL positioning procedure and the allocation of SL positioning resources.

The action may include the at least one radio device transmitting an RRC resume request in the RRC inactive state, e.g. wherein the RRC resume request is indicative of at least one of the ongoing SL positioning procedure and the allocation of SL positioning resources.

In an embodiment, the distortion may be associated with a handover procedure for the at least one radio device in the RRC connected state and/or the information is obtained over an Xn interface.

In an embodiment, the action may include the at least one radio device transmitting a measurement report and/or an RRC establishment setup complete message. E.g., the measurement report or the RRC establishment setup complete message may be indicative of at least one of the ongoing SL positioning procedure and the allocation of SL positioning resources.

The measurement report may be indicative of an event, e.g. the radio protocol event, for a handover (HO) or a conditional handover (CHO).

The obtaining of the information may comprise determining if SL positioning resources are allocated to the at least one radio device and/or the performing of the one or more actions may include a source network node of a (e.g., the afore-mentioned) handover procedure providing a dimension of the allocated SL positioning resource (e.g., via an Xn interface) and/or the performing of the action may include a target network node of a (e.g., the afore-mentioned) handover procedure receiving a dimension of the allocated SL positioning resource (e.g., via an Xn interface) and/or the one or more actions may include a target network node of a or the handover procedure allocating new SL positioning resource to the at least one radio device.

The positioning server may be embodied by a location management function (LMF) of the core network (CN). Alternatively or in addition, the positioning server may be implemented by a radio device of the radio devices involved in the SL positioning procedure, e.g., by the target radio device.

Hereinbelow, the target network node may be referred to using a reference sign 100′ as an example of the device generally referred to by the reference sign 100.

In an embodiment, the performing of the one or more actions may comprise sending the information from the at least one radio device, e.g. from the target radio device or the one or more assisting radio devices. Alternatively or in addition, the performing of the action may comprise sending the information to a positioning server. Alternatively or in addition, the performing of the action may comprise sending the information in a non-access stratum (NAS) message.

In an embodiment, the information may be obtained from the at least one radio device, e.g. from the target radio device or the one or more assisting radio devices. Alternatively or in addition, the information may be obtained at a positioning server. Alternatively or in addition, the information may be obtained in a non-access stratum (NAS) message.

In an embodiment, the performing of the action may comprise determining whether the at least one radio device, e.g. one or more assisting radio devices, is kept or replaced in the SL positioning procedure.

In an embodiment, the performing of the action may comprise allocating SL positioning resources to the one or more replacing assisting radio devices. Alternatively or in addition, the one or more replacing assisting radio devices may be allocated the SL positioning resources previously allocated to the one or more replaced assisting radio devices.

In an embodiment, the performing of the action may comprise the target radio device transmitting, on a SL to the one or more replacing assisting radio devices, an allocation message indicative of the SL positioning resources allocated to the one or more replacing assisting radio devices, optionally using PC5 RRC signaling or a medium access control control element (MAC CE).

In an embodiment, the performing of the action may comprise the network node serving the replaced assisting radio device to transmit an allocation message indicative of the SL positioning resources allocated to the replacing assisting radio devices, e.g. using Uu RRC signaling or a MAC CE.

In an embodiment, the performing of the action may comprise the positioning server (e.g. the LMF) to transmit an allocation message indicative of the SL positioning resources allocated to the replacing assisting radio devices, e.g. using NR Positioning Protocol A, NPPa, or LTE positioning protocol (LPP) signaling.

The obtained information may be indicative of a scope of an interruption caused by the distortion. Alternatively or in addition, the performing of the one or more actions may comprise determining, based on the obtained information, a scope of an interruption caused by the distortion. Alternatively or in addition, the performing of the action may comprise processing SL positioning measurements based on the scope of the interruption caused by the distortion, determining the position of the target radio device taking into account the scope of the interruption caused by the distortion, providing assistance data for the SL positioning procedure taking into account the scope of the interruption caused by the distortion, and configuring at least one parameter of the SL positioning procedure based on the scope of the interruption caused by the distortion.

For example, the processing of SL positioning measurements may exclude measurements (e.g., assistance data) affected by the interruption.

The action performed based on the obtained information related to the distortion may impact or control a distorting event causing the distortion, optionally the radio protocol event. Alternatively or in addition, the action may comprise delaying, stopping, reconfiguring the distorting event to reduce, avoid, or compensate an impact on the SL positioning procedure.

Any one of the features and steps disclosed herein can be implemented at any one of the four aspects including the network node, the target radio device, the one or more assisting radio devices, and the positioning server (e.g., a location management function, LMF).

The technique may be applied in the context of 3GPP New Radio (NR). Unlike a SL according to 3GPP LTE, a SL according to 3GPP NR can provide a wide range of QoS levels. Therefore, at least some embodiments of the technique can ensure that the SL positioning procedure is appropriate for or fulfills the QoS of the traffic.

The technique may be implemented in accordance with a 3GPP specification, e.g., for 3GPP release 17 or future release 18. The technique may be implemented for 3GPP LTE or 3GPP NR. Any embodiment of any aspect may be implemented according to at least one of the 3GPP documents TS 38.331, version 17.4.0; TS 37.355, version 17.4.0; and TS 38.455, version 17.4.0, or a change of any of these documents, e.g. in release 18. For example, either the second aspect for the UE (radio device) or the first aspect for the network node (base station) may be implemented based on the existing standard with changes (e.g., additions) to standard for at least one of the other aspects.

In any radio access technology (RAT), the technique may be implemented for SL relay selection. The SL may be implemented using proximity services (ProSe), e.g. according to a 3GPP specification.

Any radio device may be a user equipment (UE), e.g., according to a 3GPP specification. The target radio device may also be referred to as a target UE (or briefly: target). Note that the term target in the context of radio device may refer to the SL positioning procedure, while the term target in the context of a network node or a cell may refer to a handover procedure. Alternatively or in addition, the assisting radio device may also be referred to as an assisting UE or reference UE or anchor UE. Alternatively or in addition, any one of the radio devices may function as a relay radio device and/or a remote radio device, e.g. if the radio devices involved in the SL positioning procedure are partially within radio coverage of the network node.

The target radio device and/or the one or more assisting radio devices may be wirelessly connected in an uplink (UL) and/or a downlink (DL) through a Uu interface with the RAN (e.g., with the network node). Alternatively or in addition, the SL may enable a direct radio communication between proximal radio devices, e.g., the involved radio devices and/or the target radio device and/or the one or more assisting radio devices, optionally using a PC5 interface. Services provided using the SL or the PC5 interface may be referred to as proximity services (ProSe). Any radio device (e.g., the target radio device and/or the one or more assisting radio devices) supporting a SL may be referred to as ProSe-enabled radio device.

Any one of the involved radio devices, e.g. the target radio device, may further embody a positioning server performing the fourth method aspect.

The involved radio device and/or the one or more assisting radio devices and/or the (target and/or source) network node and/or the RAN and/or the positioning server may form, or may be part of, a radio network, e.g., according to the Third Generation Partnership Project (3GPP) or according to the standard family IEEE 802.11 (Wi-Fi). The first method aspect, the second method aspect, the third method aspect, and the fourth method aspect may be performed by one or more embodiments of the network node of the RAN (e.g., a base station), the target radio device, the assisting radio device, and the positioning server, respectively.

The RAN may comprise one or more network nodes (e.g., base stations), e.g., performing the first method aspect. Alternatively or in addition, the radio network may be a vehicular, ad hoc and/or mesh network comprising two or more radio devices, e.g., acting as the target radio device and/or the one or more assisting radio devices and/or the positioning server.

Any of the radio devices may be a 3GPP user equipment (UE) or a Wi-Fi station (STA). The radio device may be a mobile or portable station, a device for machine-type communication (MTC), a device for narrowband Internet of Things (NB-IoT) or a combination thereof. Examples for the UE and the mobile station include a mobile phone, a tablet computer and a self-driving vehicle. Examples for the portable station include a laptop computer and a television set. Examples for the MTC device or the NB-IoT device include robots, sensors and/or actuators, e.g., in manufacturing, automotive communication and home automation. The MTC device or the NB-IoT device may be implemented in a manufacturing plant, household appliances and consumer electronics.

Whenever referring to the RAN, the RAN may be implemented by one or more network nodes (e.g., base stations).

The target radio device may be wirelessly connected or connectable (e.g., according to a radio resource control, RRC, state or active or inactive mode) with the assisting radio device and/or the network node (e.g., at least one base station of the RAN). The assisting radio device may be wirelessly connected or connectable (e.g., according to a radio resource control, RRC, state or active or inactive mode) with the target radio device and/or one or more other assisting radio devices and/or the network node (e.g., at least one base station of the RAN).

The network node (e.g., a base station) may encompass any station that is configured to provide radio access to any of the radio devices. The base station may be a cell, a transmission and reception point (TRP), a central unit (CU), a distributed unit (DU), a radio access node or an access point (AP). The base station and/or the relay radio device may provide a data link to a host computer providing user data to the (e.g., target) radio device or gathering user data from the (e.g., target) radio device. Examples for the network node or base station may include a 3G base station or Node B (NB), 4G base station or eNodeB (eNB), a 5G base station or gNodeB (gNB), a Wi-Fi AP and a network controller (e.g., according to Bluetooth, ZigBee or Z-Wave).

The RAN may be implemented according to the Global System for Mobile Communications (GSM), the Universal Mobile Telecommunications System (UMTS), 3GPP Long Term Evolution (LTE) and/or 3GPP New Radio (NR).

Any aspect of the technique may be implemented on a Physical Layer (PHY), a Medium Access Control (MAC) layer, a Radio Link Control (RLC) layer, a packet data convergence protocol (PDCP) layer, and/or a Radio Resource Control (RRC) layer of a protocol stack for the radio communication.

Herein, referring to a protocol of a layer may also refer to the corresponding layer in the protocol stack. Vice versa, referring to a layer of the protocol stack may also refer to the corresponding protocol of the layer. Any protocol may be implemented by a corresponding method.

As to another aspect, a computer program product is provided. The computer program product comprises program code portions for performing any one of the steps of the method aspect disclosed herein when the computer program product is executed by one or more computing devices. The computer program product may be stored on a computer-readable recording medium. The computer program product may also be provided for download, e.g., via the radio network, the RAN, the Internet and/or the host computer. Alternatively, or in addition, the method may be encoded in a Field-Programmable Gate Array (FPGA) and/or an Application-Specific Integrated Circuit (ASIC), or the functionality may be provided for download by means of a hardware description language.

As to device aspects, a device according to any one of the embodiments 29 to 44 is provided. The first, second, third, and/or fourth devices aspect may be configured to perform any one of the steps of the first, second, third, and/or fourth method aspect. Alternatively or in addition, the device comprises processing circuitry (e.g., at least one processor and a memory). Said memory comprises instructions executable by said at least one processor whereby the device is operative to perform any one of the steps of the respective method aspect.

The first device aspect may be embodied by a network node of a RAN.

The second device aspect may be embodied by a target radio device of the SL positioning procedure.

The third device aspect may be embodied by an assisting radio device of the SL positioning procedure.

The fourth device aspect may be embodied by a positioning sever of the SL positioning procedure.

As to a still further aspect a communication system including a host computer is provided. The host computer comprises a processing circuitry configured to provide user data, e.g., included results of the SL positioning procedure. The host computer further comprises a communication interface configured to forward the instructions as to the SL positioning procedure to a cellular network (e.g., the RAN and/or the base station) for transmission to a UE. A processing circuitry of the cellular network is configured to execute any one of the steps of the first method aspect and/or fourth method aspect. Alternatively or in addition, the UE comprises a radio interface and processing circuitry, which is configured to execute any one of the steps of the second and/or third and/or fourth method aspects.

The communication system may further include the UE. Alternatively, or in addition, the cellular network may further include one or more base stations configured for radio communication with the UE and/or to provide a data link between the UE and the host computer using any one of the method aspects.

The processing circuitry of the host computer may be configured to execute a host application, thereby providing the measurement results and/or instructions for the SL positioning procedure and/or any host computer functionality described herein. Alternatively, or in addition, the processing circuitry of the UE may be configured to execute a client application associated with the host application.

Any one of the devices, the (target or assisting) UE, the base station, the communication system or any node or station for embodying the technique may further include any feature disclosed in the context of the method aspect, and vice versa. Particularly, any one of the units and modules disclosed herein may be configured to perform or initiate one or more of the steps of the method aspect.

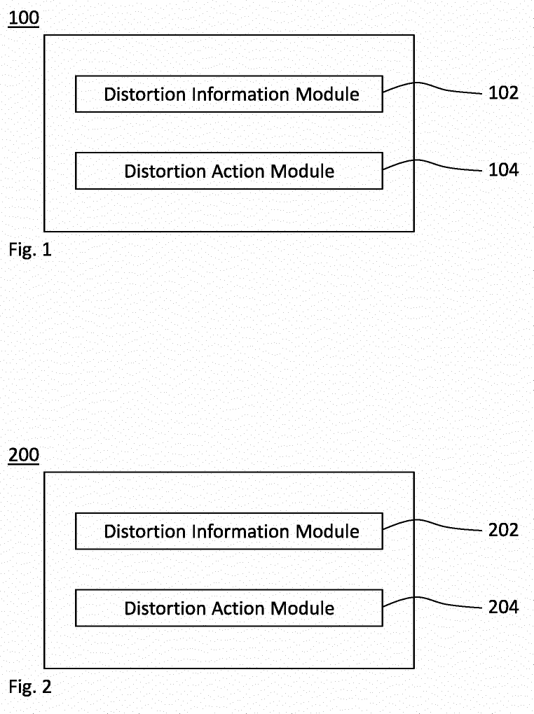

FIG. 1 schematically illustrates a block diagram of an embodiment of a device for handling (e.g., a distortion in) a SL positioning procedure according to a first device aspect. The device is generically referred to by reference sign 100.

The device 100 comprises a distortion information module 102 that obtains (e.g., receives) information indicative of a distortion of a radio link of at least one radio device among radio devices involved in the SL positioning procedure. The device 100 further comprises a distortion action module 104 that performs one or more actions that handle the distortion based on the obtained information.

Any of the modules of the device 100 may be implemented by units configured to provide the corresponding functionality.

The device 100 may also be referred to as, or may be embodied by, the network node (or briefly: gNB). The network node 100 and the target and/or assisting radio devices may be in direct radio communication, e.g., at least for the allocating of SL positioning resources.

FIG. 2 schematically illustrates a block diagram of an embodiment of a device for handling (e.g., a distortion in) a SL positioning procedure according to a second device aspect. The device is generically referred to by reference sign 200.

The device 200 comprises a distortion information module 202 that obtains (e.g., receives) information indicative of a distortion of a radio link of at least one radio device among radio devices involved in the SL positioning procedure. The device 200 further comprises a distortion action module 204 that performs one or more actions that handle the distortion based on the obtained information.

Any of the modules of the device 200 may be implemented by units configured to provide the corresponding functionality.

The device 200 may also be referred to as, or may be embodied by, the target radio device (or briefly: target). The target radio device 200 and the network node and/or assisting radio devices may be in direct radio communication, e.g., at least for the SL positioning procedure and the allocating of SL positioning resources, respectively.

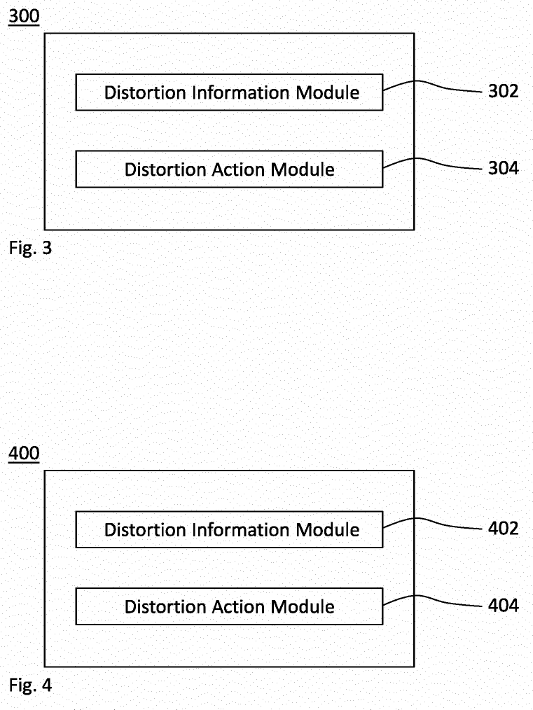

FIG. 3 schematically illustrates a block diagram of an embodiment of a device for handling (e.g., a distortion in) a SL positioning procedure according to a third device aspect. The device is generically referred to by reference sign 300.

The device 300 comprises a distortion information module 302 that obtains (e.g., receives) information indicative of a distortion of a radio link of at least one radio device among radio devices involved in the SL positioning procedure. The device 300 further comprises a distortion action module 304 that performs one or more actions that handle the distortion based on the obtained information.

Any of the modules of the device 300 may be implemented by units configured to provide the corresponding functionality.

The device 300 may also be referred to as, or may be embodied by, the assisting radio device (or briefly: reference or anchor). The assisting radio device 300 and the network node and/or the target radio device may be in direct radio communication, e.g., at least for the SL positioning procedure and the allocating of SL positioning resources, respectively.

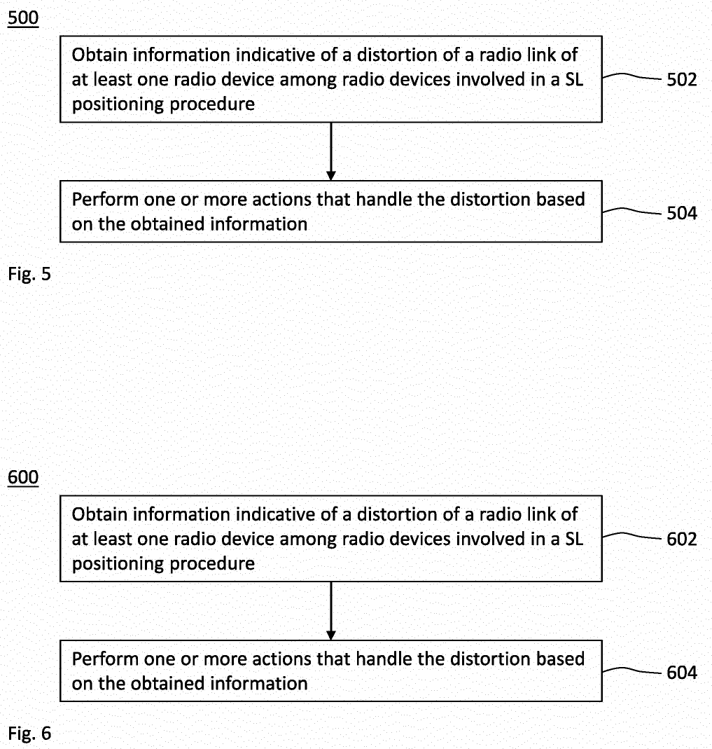

FIG. 4 schematically illustrates a block diagram of an embodiment of a device for handling (e.g., a distortion in) a SL positioning procedure according to a fourth device aspect. The device is generically referred to by reference sign 400.

The device 400 comprises a distortion information module 402 that obtains (e.g., receives) information indicative of a distortion of a radio link of at least one radio device among radio devices involved in the SL positioning procedure. The device 400 further comprises a distortion action module 404 that performs one or more actions that handle the distortion based on the obtained information.

Any of the modules of the device 400 may be implemented by units configured to provide the corresponding functionality.

The device 400 may also be referred to as, or may be embodied by, the positioning server (or briefly: LMF). The positioning server 400 and the network node and/or the involved radio devices may be in communication, e.g., at least for the information and the action.

FIG. 5 shows an example flowchart for a method 500 of handling (e.g., a distortion in) a SL positioning procedure. The method comprises the steps 502 and 504 illustrated in FIG. 5.

The method 500 may be performed by the device 100. For example, the modules 102 and 104 may perform the steps 502 and 504, respectively.

FIG. 6 shows an example flowchart for a method 600 of handling (e.g., a distortion in) a SL positioning procedure. The method comprises the steps 602 and 604 illustrated in FIG. 6.

The method 600 may be performed by the device 200. For example, the modules 202 and 204 may perform the steps 602 and 604, respectively.

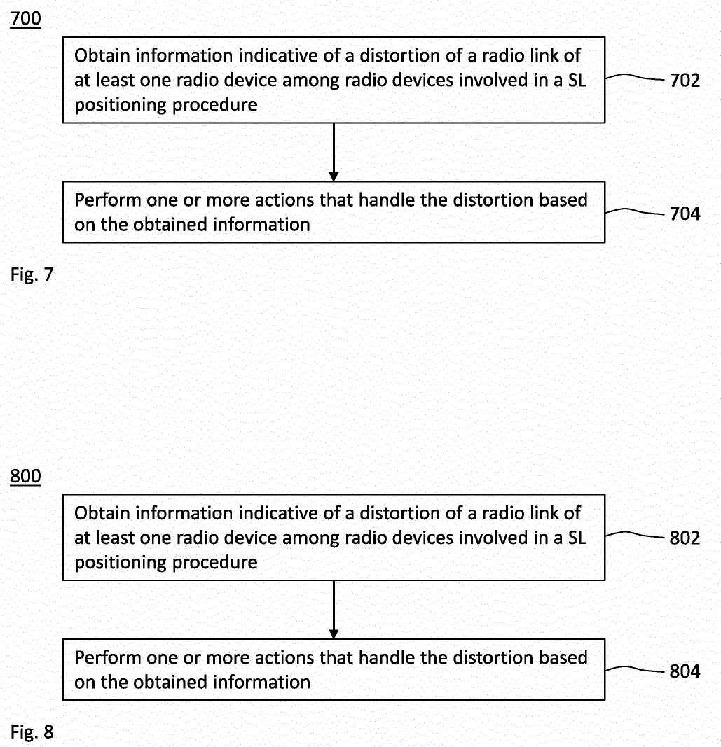

FIG. 7 shows an example flowchart for a method 700 of handling (e.g., a distortion in) a SL positioning procedure. The method comprises the steps 702 and 704 illustrated in FIG. 7.

The method 700 may be performed by the device 300. For example, the modules 302 and 304 may perform the steps 702 and 704, respectively.

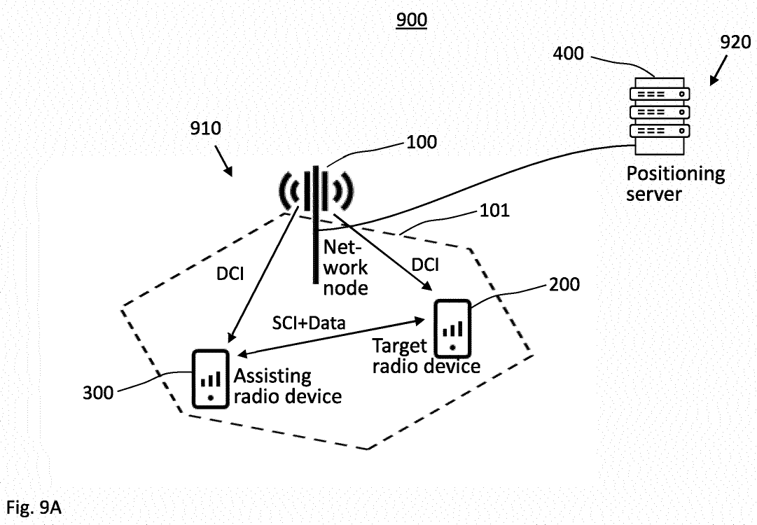

FIG. 8 shows an example flowchart for a method 800 of handling (e.g., a distortion in) a SL positioning procedure. The method comprises the steps 802 and 804 illustrated in FIG. 8.

The method 800 may be performed by the device 400. For example, the modules 402 and 404 may perform the steps 802 and 804, respectively.

The technique may be applied to uplink (UL), downlink (DL) or direct communications between radio devices, e.g., device-to-device (D2D) communications or sidelink (SL) communications.

Each of the network node 100, the target radio device 200, the assisting radio device 300, and the positioning server 400 may be a node of a radio network, e.g., a radio device or a base station. Herein, any radio device may be a mobile or portable station and/or any radio device wirelessly connectable to a network node (e.g., a base station) of the RAN, or to another radio device. For example, the radio device may be a user equipment (UE), a device for machine-type communication (MTC) or a device for (e.g., narrowband) Internet of Things (IoT). Two or more radio devices may be configured to wirelessly connect to each other, e.g., in an ad hoc radio network or via a 3GPP SL connection. Furthermore, any base station may be a station providing radio access, may be part of a radio access network (RAN) and/or may be a node connected to the RAN for controlling the radio access. For example, the base station may be an access point, for example a Wi-Fi access point.

Furthermore, “predefined” may encompass stored in memory (e.g., in a Subscriber Identity Module, SIM) of the target or assisting radio device 200 or 300, or hard-coded or hard-wired in the target or assisting radio device 200 or 300, or preconfigured or configured by the network node 100 or the radio access network (RAN) for the target or assisting radio device 200 or 300 (e.g., preconfigured while in coverage prior to performing the method 600 or 700 out of coverage, or configured while in coverage when performing the method 600 or 700).

A radio spectrum used for the SL positioning resources may be shared by multiple RATs, e.g. unlicensed spectrum.

Herein, a list of the form A, B, and/or C (also written as A, B and/or C) may correspond to at least one or each of A, B, and C, i.e., A and/or B and/or C.

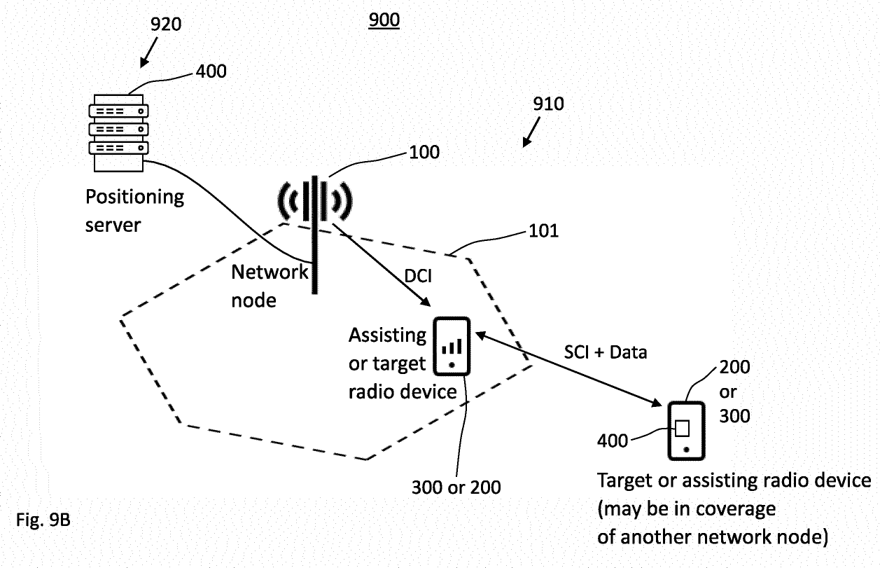

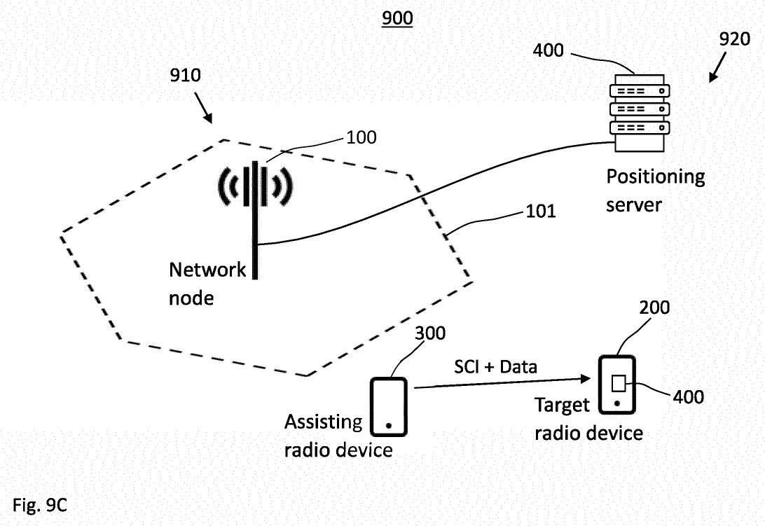

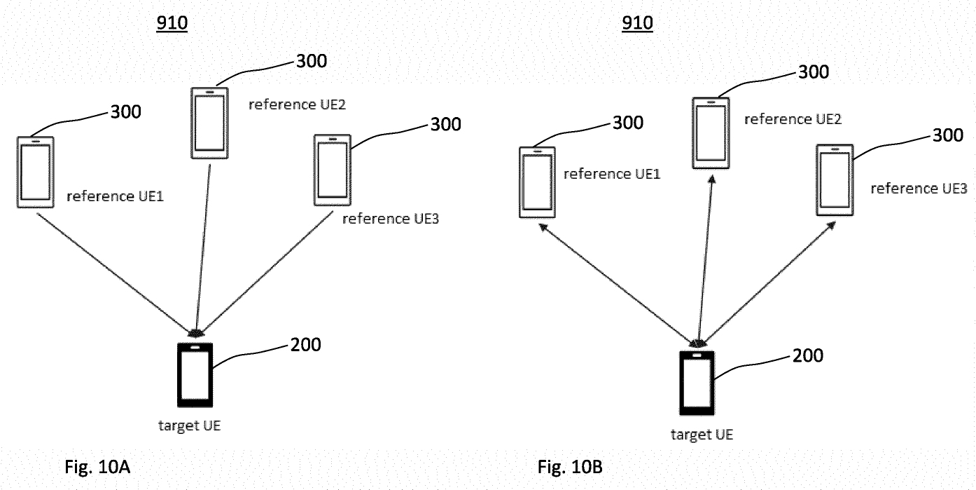

FIGS. 9A, 9B and 9C schematically illustrate SL positioning for a target UE in different coverage scenarios, including in-coverage (or full coverage), partial coverage, and out-of-coverage, respectively.

In FIGS. 9A, 9B and 9C, the assisting UE 300 (which may be also referred to as anchor UE or reference UE) provides SL measurement assistance to the target UE. Any one of the assisting UE 300 and the target UE 200 may act as transmitting UE (TX UE) and receiving UE (RX UE), respectively, e.g. depending on which one of the UEs 200 and 300 is transmitting and receiving, respectively, a sidelink positioning reference signal (SL PRS).

Moreover, e.g. in case one of a partial coverage (e.g., as schematically illustrated in FIG. 9B), i.e., if only one of the assisting UE 300 and the target UE 200 is in coverage and the other one is out of coverage (e.g., with respect to the node 100), the UE in coverage may act as a relay UE for a relayed radio communication between the UE out of coverage (i.e., the remote UE) and the node 100.

For a target UE 200 out of coverage (e.g., according to FIG. 9B or 9C), there may be different options for the target UE 200 to get positioned. In one option, the target UE 200 may choose to connect to the network via a SL U2N relay UE, e.g. the 300, which may or may not embody the third aspect. In this case, the network 910 (e.g., the node 100) may be involved in the positioning procedure for the target UE 200. In another option, the target UE 200 may apply UE-based positioning by involving an assisting UE 300. If there is not any assisting UE 300 found in the proximity, the target UE 200 may reach an assisting UE 300 in further range via a U2U relay UE (which may or may not embody the third aspect).

In any embodiment, the SL positioning procedure may be combined with positioning in Uu (i.e., RAN-based positioning).

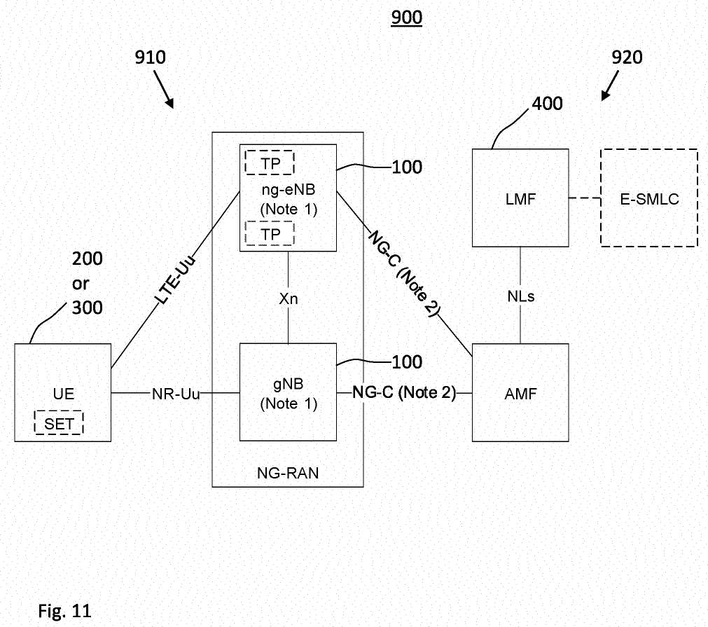

Positioning has been a topic in LTE standardization since 3GPP Release 9. The primary objective is to fulfill regulatory requirements for emergency call positioning. Positioning in NR is proposed to be supported by the architecture shown in FIG. 11. Location Management Function (LMF) is the location node in NR. There are also interactions between the location node and the gNodeB via a NR Positioning Protocol A (NRPPa protocol). The interaction between the gNodeB and the device is supported via the Radio Resource Control (RRC) protocol.

The following SL positioning measurements performed by a target UE 200 are used for determining position (e.g. location and/or orientation) of that target UE 200. The target UE 200 performs a SL positioning measurement on SL reference signals (e.g. SL PRS or SL SRS) transmitted by one or more other (anchor) UEs 300 and/or on SL reference signals (e.g. SL PRS or SL SRS) transmitted by the target UE 200 itself. SL positioning reference signal (SL PRS) is being standardized to be used for the SL measurements.

Examples of the possible SL positioning measurements are:
SL Rx-tx time difference or RTT measurement (can be defined as T_{SL-RX}-T_{SL-TX}, Where T_{SL-RX} is the received timing of a SL time resource #i (i.e., the resource counted or labelled by the integer i) from an anchor UE, and T_{SL-TX} is the transmit timing of SL time resource #j closest in time to the time resource #i received from the anchor UE).
SL RSTD measurement (SL reference signal time difference between two anchor UEs i.e. between an anchor UE i and a reference anchor UE j).
SL RSRP measurement (SL PRS reference signal received power, SL PRS-RSRP or SL RSRP, is the linear average over the power contributions (in [W]) of the resource elements that carry SL PRS reference signals).
SL RSRPP measurement (SL PRS reference signal received power, SL PRS-RSRPP or SL RSRPP, is the linear average of the channel response at the i-th path delay of the of the resource elements that carry SL PRS reference signals; SL RSRPP for the 1st path delay is the power contribution corresponding to the first detected path in time).
SL RTOA measurement (the beginning of SL time resource #i containing e.g. SL PRS received in the target UE, relative to a reference time e.g. the RTOA Reference Time.
SL Azimuth angle of Arrival (AoA) measurement (Azimuth angle of Arrival of e.g. SL PRS transmitted by the anchor UE and measured by the target UE).
SL Zenith angle of Arrival (ZoA) measurement (Zenith angle of Arrival of e.g. SL PRS transmitted by the anchor UE and measured by the target UE).
SL pathloss measurement (pathloss measurement based on SL positioning reference signals e.g., a SL PRS or a sounding reference signal, SL SRS).

The same positioning methods including DL-TDOA, UL-TDOA, and Multi-RTT etc. may be applicable for SL-based positioning. For these methods, multiple assisting (i.e. reference) UEs 300 may be used or required, e.g. as shown in the FIGS. 10A and 10B described below.

For SL-based positioning, certain method such as TDOA may require tight synchronization among multiple assisting/reference UEs 300 so that the transmissions of positioning reference signals from these reference UEs 300 can arrive at the target UE 200 in a synchronized fashion. This can improve both positioning accuracy and avoid interference among reference UEs 300.

FIGS. 10A and 10B schematically illustrate SL positioning and ranging. More specifically, FIG. 10A illustrates SL positioning using TDOA. FIG. 10B illustrates SL positioning using Multi-RTT.

According to the latest 3GPP discussion progress, it has been agreed to support two different schemes to position a target UE based on SL positioning.
Scheme 1: The target UE 200 and/or anchor UEs 300 measure(s) or perform(s) SL positioning transmissions using SL resources scheduled/allocated by the gNB 100.
Scheme 2: The target UE 200 and/or anchor UEs 300 measure(s) or perform(s) SL positioning transmissions using SL resources scheduled/allocated by the UE 200 (or 300) itself.

Scheme 1 may correspond to Mode 1 random access (RA) operation, while scheme 2 corresponds to Mode 2 RA operation.

FIG. 11 is schematically indicative of protocols for location services (LCS) according to 3GPP Release 15 for a next generation radio access network (NG-RAN), which may be used or extended by an embodiment of any aspect of the technique. As to Note 1 in FIG. 11, the gNB and ng-eNB may not always both be present. As to Note 2 in FIG. 11, when both the gNB and ng-eNB are present, the interface NG-C is only present for one of them.

Using or extending any feature of the legacy LTE standards, an embodiment may comprise or adjust at least one of the following positioning methods:
Enhanced Cell ID. Essentially cell ID information to associate the device to the serving area of a serving cell, and then additional information to determine a finer granularity position.
Assisted Global Navigation Satellite System (GNSS) may use GNSS information retrieved by the device and may be supported by assistance information provided to the device from Evolved Serving Mobile Location Center (E-SMLC).
OTDOA (Observed Time Difference of Arrival). The device estimates the time difference of reference signals from different base stations and sends to the E-SMLC for multilateration.
UTDOA (Uplink TDOA). The device is requested to transmit a specific waveform that is detected by multiple location measurement units (e.g. an eNB) at known positions. These measurements are forwarded to E-SMLC for multilateration
Sensor methods such as Biometric pressure sensor which provides vertical position of the device and Inertial Motion Unit (IMU) which provides displacement.

Alternatively or in addition, any embodiment may use or extend at least one of the following positioning methods supported by NR (e.g., as RAT-dependent positioning methods).

Downlink time difference of arrival (DL-TDOA):

The DL TDOA positioning method makes use of the DL RSTD (and optionally DL PRS RSRP) of downlink signals received from multiple (Transmission Points) TPs, at the UE. The UE measures the DL RSTD (and optionally DL PRS RSRP) of the received signals using assistance data received from the positioning server, and the resulting measurements are used along with other configuration information to locate the UE in relation to the neighboring TPs.

Multiple round trip times (Multi-RTT): The Multi-RTT positioning method makes use of the UE Rx-Tx measurements and DL PRS RSRP of downlink signals received from multiple Transmission Reception Points (TRPs), measured by the UE and the measured gNB Rx-Tx measurements and UL SRS-RSRP at multiple TRPs of uplink signals transmitted from UE.

Uplink time difference of arrival (UL-TDOA):

The UL TDOA positioning method makes use of the UL TDOA (and optionally UL SRS-RSRP) at multiple Reception Points (RPs) of uplink signals transmitted from UE. The RPs measure the UL TDOA (and optionally UL SRS-RSRP) of the received signals using assistance data received from the positioning server, and the resulting measurements are used along with other configuration information to estimate the location of the UE.

Downlink angle of departure (DL-AoD):

The DL AoD positioning method makes use of the measured DL PRS RSRP of downlink signals received from multiple TPs, at the UE. The UE measures the DL PRS RSRP of the received signals using assistance data received from the positioning server, and the resulting measurements are used along with other configuration information to locate the UE in relation to the neighboring TPs.

Uplink angle of arrival (UL-AoA):

The UL AoA positioning method makes use of the measured azimuth and zenith of arrival at multiple RPs of uplink signals transmitted from the UE. The RPs measure an azimuth angle of arrival (A-AoA) and an zenith angle of arriva (Z-Alternatively or in addition,) of the received signals using assistance data received from the positioning server, and the resulting measurements are used along with other configuration information to estimate the location of the UE.

NR Enhanced Cell Identity (NR-ECID):

NR Enhanced Cell ID (NR E-CID) positioning refers to techniques which use additional UE measurements and/or NR radio resource and other measurements to improve the UE location estimate.

The positioning modes can be categorized in below three areas:
UE-Assisted: The UE performs measurements with or without assistance from the network and sends these measurements to the E-SMLC (which may embody the device 400) where the position calculation may take place.
UE-Based: The UE performs measurements and calculates its own position with assistance from the network.
Standalone: The UE performs measurements and calculates its own position without network assistance.

Any embodiment may use SL communication between the involved UEs 200 and/or 300, e.g. for transmitting and/or receiving reference signals (RSs) and/or measurement results of the SL positioning procedure and/or control instructions for the SL positioning procedure.

The SL communication may use or extend SL transmissions and/or receptions in 3gpp NR.

Sidelink transmissions over NR are specified for Release 16. These are enhancements of the ProSe (PROximity-based SErvices) specified for LTE. For example, the following four enhancements were introduced to NR sidelink transmissions.
Support for unicast and groupcast transmissions are added in NR sidelink. For unicast and groupcast, the physical sidelink feedback channel (PSFCH) is introduced for a receiver UE to reply the decoding status to a transmitter UE.
Grant-free transmissions, which are adopted in NR uplink transmissions, are also provided in NR sidelink transmissions, to improve the latency performance.
To alleviate resource collisions among different sidelink transmissions launched by different UEs, it enhances channel sensing and resource selection procedures, which also lead to a new design of a physical SL control channel (PSCCH).
To achieve a high connection density, congestion control and thus the quality of Service (QOS) management is supported in NR sidelink transmissions.

To enable the above enhancements, at least one of the following physical channels and/or reference signals specified in NR (some of which provide features also available in LTE) may be used in an embodiment.
PSSCH (Physical Sidelink Shared Channel, SL version of PDSCH): The PSSCH is transmitted by a sidelink transmitter UE, which conveys sidelink transmission data, system information blocks (SIBs) for radio resource control (RRC) configuration, and a part of the sidelink control information (SCI).
PSFCH (Physical Sidelink, SL version of PUCCH): The PSFCH is transmitted by a sidelink receiver UE for unicast and groupcast, which conveys 1 bit information over 1 RB for the HARQ acknowledgement (ACK) and the negative ACK (NACK). In addition, channel state information (CSI) is carried in the medium access control (MAC) control element (CE) over the PSSCH instead of the PSFCH.
PSCCH (Physical Sidelink Common Control Channel, SL version of PDCCH): When the traffic to be sent to a receiver UE arrives at a transmitter UE, a transmitter UE should first send the PSCCH, which conveys a part of SCI (Sidelink Control information, SL version of DCI) to be decoded by any UE for the channel sensing purpose, including the reserved time-frequency resources for transmissions, demodulation reference signal (DMRS) pattern and antenna port, etc.
Sidelink Primary/Secondary Synchronization Signal (S-PSS/S-SSS): Similar to downlink transmissions in NR, in sidelink transmissions, primary and secondary synchronization signals (called S-PSS and S-SSS, respectively) are supported. Through detecting the S-PSS and S-SSS, a UE is able to identify the sidelink synchronization identity (SSID) from the UE sending the S-PSS/S-SSS. Through detecting the S-PSS/S-SSS, a UE is therefore able to know the characteristics of the UE transmitter the S-PSS/S-SSS. A series of process of acquiring timing and frequency synchronization together with SSIDs of UEs is called initial cell search.

It is noted that the UE 200 or 300 sending the S-PSS and/or S-SSS may not be necessarily involved in sidelink transmissions, and a node (UE 200 or 300 or eNB/gNB 100) sending the S-PSS and/or S-SSS is called a synchronization source. There are 2 S-PSS sequences and 336 S-SSS sequences forming a total of 672 SSIDs in a cell.
Physical Sidelink Broadcast Channel (PSBCH): The PSBCH is transmitted along with the S-PSS/S-SSS as a synchronization signal/PSBCH block (SSB). The SSB has the same numerology as PSCCH/PSSCH on that carrier, and an SSB should be transmitted within the bandwidth of the configured BWP. The PSBCH conveys information related to synchronization, such as the direct frame number (DFN), indication of the slot and symbol level time resources for sidelink transmissions, in-coverage indicator, etc. The SSB is transmitted periodically at every 160 ms.
DMRS, phase tracking reference signal (PT-RS), channel state information reference signal (CSIRS): These physical reference signals supported by NR downlink/uplink transmissions are also adopted by sidelink transmissions. Similarly, the PT-RS is only applicable for FR2 transmission.

Any embodiment may use the two-stage sidelink control information (SCI). This a version of the downlink control information (DCI) for SL. Unlike the DCI, only a part (i.e., the first stage) of the SCI is sent on the PSCCH. This part is used for channel sensing purposes (including the reserved time-frequency resources for transmissions, demodulation reference signal (DMRS) pattern and antenna port, etc.) and can be read by all UEs while the remaining part (i.e., the second stage) includes scheduling and control information such as an 8-bits source identity (ID) and a 16-bits destination ID, NDI, RV and HARQ process ID. The second part is sent on the PSSCH to be decoded by the receiver UE.

Similar as for Proximity Services (ProSe) in LTE, NR sidelink transmissions have the following two modes of resource allocations:
Mode 1: Sidelink resources are scheduled by a gNB 100.
Mode 2: The UE 200 or 300 autonomously selects sidelink resources from one or more (pre-)configured sidelink resource pools based on the channel sensing mechanism.

For the in-coverage UE, a gNB can be configured to adopt Mode 1 or Mode 2. For the out-of-coverage UE, only Mode 2 can be adopted.

As in LTE, scheduling over the sidelink in NR is done in different ways for Mode 1 and Mode 2.

Mode 1 supports at least two kinds of grants including dynamic grant and configured grant.

### Dynamic Grant

When the traffic to be sent over sidelink arrives at a transmitter UE, this UE should launch the four-message exchange procedure to request sidelink resources from a gNB (SR on UL, grant, BSR on UL, grant for data on SL sent to UE). During the resource request procedure, a gNB may allocate a sidelink radio network temporary identifier (SL-RNTI) to the transmitter UE. If this sidelink resource request is granted by a gNB, then a gNB indicates the resource allocation for the PSCCH and the PSSCH in the downlink control information (DCI) conveyed by PDCCH with CRC scrambled with the SL-RNTI. When a transmitter UE receives such a DCI, a transmitter UE can obtain the grant only if the scrambled CRC of DCI can be successfully solved by the assigned SL-RNTI. A transmitter UE then indicates the time-frequency resources and the transmission scheme of the allocated PSSCH in the PSCCH, and launches the PSCCH and the PSSCH on the allocated resources for sidelink transmissions. When a grant is obtained from a gNB, a transmitter UE can only transmit a single TB. As a result, this kind of grant is suitable for traffic with a loose latency requirement.

### Configured Grant

For the traffic with a strict latency requirement, performing the four-message exchange procedure to request sidelink resources may induce unacceptable latency. In this case, prior to the traffic arrival, a transmitter UE may perform the four-message exchange procedure and request a set of resources. If a grant can be obtained from a gNB, then the requested resources are reserved in a periodic manner. Upon traffic arriving at a transmitter UE, this UE can launch the PSCCH and the PSSCH on the upcoming resource occasion. In fact, this kind of grant is also known as grant-free transmissions.

In both dynamic grant and configured grant, a sidelink receiver UE (e.g., UE 200) cannot receive the DCI (since it is addressed to the transmitter UE, e.g., UE 300), and therefore a receiver UE should perform blind decoding to identify the presence of PSCCH and find the resources for the PSSCH through the SCI.

When a transmitter UE launches the PSCCH, a cyclic redundancy check (CRC) is also inserted in the SCI without any scrambling.

Any embodiment of the method 600 and/or 700 may use Mode 2 Resource allocation (e.g., based on an allocation message transmitted in the method 500).

In the Mode 2 resource allocation, when traffic arrives at a transmitter UE 200 or 300, this transmitter UE should autonomously select resources for the PSCCH and the PSSCH. To further minimize the latency of the feedback HARQ ACK/NACK transmissions and subsequently retransmissions, a transmitter UE may also reserve resources for PSCCH and/or PSSCH for retransmissions. To further enhance the probability of successful TB decoding at one shot and thus suppress the probability to perform retransmissions, a transmitter UE may repeat the TB transmission along with the initial TB transmission. This mechanism is also known as blind retransmission. As a result, when traffic arrives at a transmitter UE, then this transmitter UE should select resources for the following transmissions:
1) The PSSCH associated with the PSCCH for initial transmission and blind retransmissions.
2) The PSSCH associated with the PSCCH for retransmissions.

Since each transmitter UE in sidelink transmissions should autonomously select resources for above transmissions, how to prevent different transmitter UEs from selecting the same resources turns out to be a critical issue in Mode 2. A particular resource selection procedure is therefore imposed to Mode 2 based on channel sensing. The channel sensing algorithm involves measuring RSRP on different subchannels and requires knowledge of the different UEs power levels of DMRS on the PSSCH or the DMRS on the PSCCH depending on the configuration. This information is known only after receiver SCI launched by (all) other UEs. The sensing and selection algorithm is rather complex.

As described in clause 6.3.2.2 in the 3GPP document TR 37.985, version 17.1.1, Mode 2 is for UE-autonomous resource selection. Its basic structure is of a UE 200 or 300 sensing, within a (pre-)configured resource pool, which resources are not in use by other UEs 300 or 200, respectively, with higher-priority traffic, and choosing an appropriate amount of such resources for its own transmissions. Having selected such resources, the UE can transmit and re-transmit in them a certain number of times, or until a cause of resource reselection is triggered.

The mode 2 sensing procedure can select and then reserve resources for a variety of purposes reflecting that NR V2X introduces sidelink HARQ in support of unicast and groupcast in the physical layer. It may reserve resources to be used for a number of blind (re-)transmissions or HARQ-feedback-based (re-)transmissions of a transport block, in which case the resources are indicated in the SCI(s) scheduling the transport block. Alternatively, it may select resources to be used for the initial transmission of a later transport block, in which case the resources are indicated in an SCI scheduling a current transport block, in a manner similar to the LTE-V2X scheme (clause 5.2.2.2). Finally, an initial transmission of a transport block can be performed after sensing and resource selection, but without a reservation.

The first-stage SCIs transmitted by UEs 200 or 300 on PSCCH indicate the time-frequency resources in which the UE will transmit a PSSCH. These SCI transmissions are used by sensing UEs to maintain a record of which resources have been reserved by other UEs in the recent past. When a resource selection is triggered (e.g. by traffic arrival or a re-selection trigger), the UE considers a sensing window which starts a (pre-)configured time in the past and finishes shortly before the trigger time. The window can be either 1100 ms or 100 ms wide, with the intention that the 100 ms option is particularly useful for aperiodic traffic, and 1100 ms particularly for periodic traffic. A sensing UE also measures the SL-RSRP in the slots of the sensing window, which implies the level of interference which would be caused and experienced if the sensing UE were to transmit in them. In NR-V2X, SL-RSRP is a (pre-)configurable measurement of either PSSCH-RSRP or PSCCH-RSRP.

The sensing UE 200 or 300 then selects resources for its (re-)transmission(s) from within a resource selection window. The window starts shortly after the trigger for (re-)selection of resources, and cannot be longer than the remaining latency budget of the packet due to be transmitted. Reserved resources in the selection window with SL-RSRP above a threshold are excluded from being candidates by the sensing UE, with the threshold set according to the priorities of the traffic of the sensing and transmitting UEs. Thus, a higher priority transmission from a sensing UE can occupy resources which are reserved by a transmitting UE with sufficiently low SL-RSRP and sufficiently lower-priority traffic.

If the set of resources in the selection window which have not been excluded is less than a certain proportion of the available resources within the window, the SL-RSRP exclusion threshold is relaxed in 3 dB steps. The proportion is set by (pre-)configuration to 20%, 35%, or 50% for each traffic priority. The UE selects an appropriate amount of resources randomly from this non-excluded set. The resources selected are not in general periodic. Up to three resources can be indicated in each SCI transmission, which can each be independently located in time and frequency. When the indicated resources are for semi-persistent transmission of another transport block, the range of supported periodicities is expanded compared to LTE-V2X, in order to cover the broader set of envisioned use cases in NR-V2X.

Shortly before transmitting in a reserved resource, a sensing UE re-evaluates the set of resources from which it can select, to check whether its intended transmission is still suitable, taking account of late-arriving SCIs due, typically, to an aperiodic higher-priority service starting to transmit after the end of the original sensing window. If the reserved resources would not be part of the set for selection at this time (T3), then new resources are selected from the updated resource selection window. The cut-off time T3 is long enough before transmission to allow the UE to perform the calculations relating to resource re-selection.

The timeline of the sensing and resource (re-)selection windows with respect to the time of trigger n, are shown in FIG. 6.3.2.2-2(a) in the 3GPP document TR 37.985, version 17.1.1, and the effect of the possibility of re-evaluation before first use of the reservation in FIG. 6.3.2.2-2(b) in the 3GPP document TR 37.985, version 17.1.1.

There are a number of triggers for resource re-selection, several of which are similar to LTE-V2X in Clause 5.2.2.2 in the document TR 37.985, version 17.1.1. In addition, there is the possibility to configure a resource pool with a pre-emption function designed to help accommodate aperiodic sidelink traffic, so that a UE reselects all the resources it has already reserved in a particular slot if another nearby UE with higher priority indicates it will transmit in any of them, implying a high-priority aperiodic traffic arrival at the other UE, and the SL-RSRP is above the exclusion threshold. The application of pre-emption can apply between all priorities of data traffic, or only when the priority of the pre-empting traffic is higher than a threshold and higher than that of the pre-empted traffic. A UE does not need to consider the possibility of pre-emption later than time T3 before the particular slot containing the reserved resources.

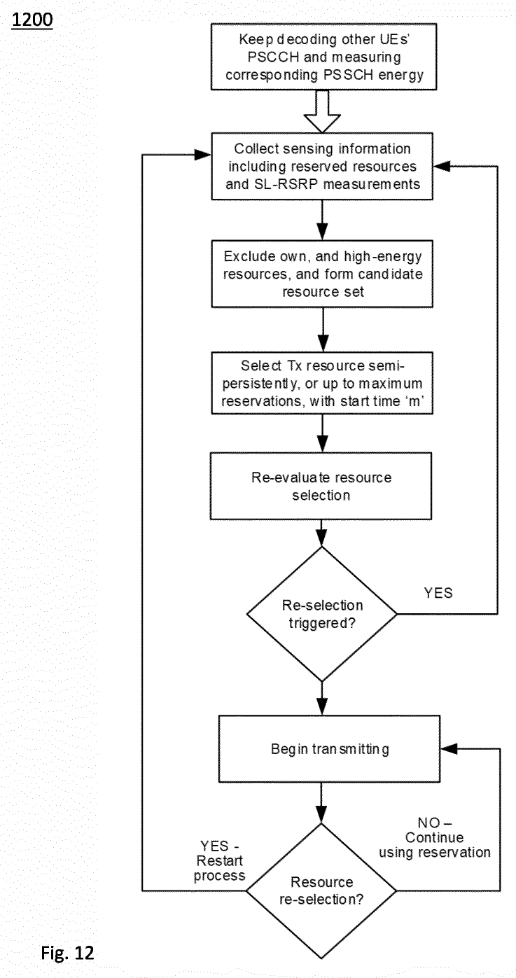

Any embodiment may perform a sensing and resource (re-)selection procedures, e.g. as summarized in FIG. 12 or FIG. 6.3.2.2-1 of the 3GPP document TR 37.985, version 17.1.1.

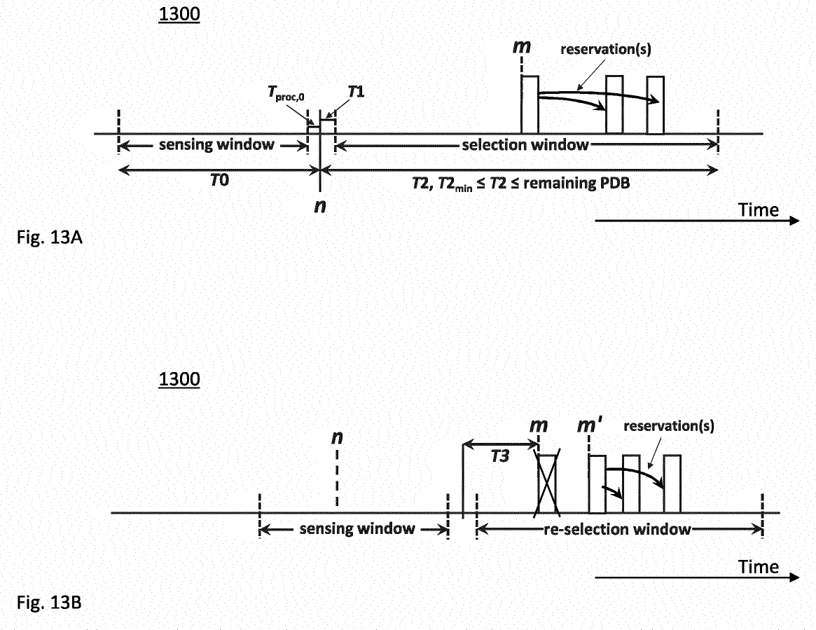

Any embodiment may perform a timeline of a sensing and resource (re-)selection procedure triggered at time n, e.g. without re-evaluation before (m-T3). For example, as illustrated in FIG. 13A or FIG. 6.3.2.2-2(a) of the 3GPP document in TR 37.985, version 17.1.1, a first reserved resource for the sensing UE is at time m.

Alternatively or in addition, any embodiment may perform a timeline of a sensing and resource (re-)selection procedure originally triggered at time n, which has a first reserved resource at time m. When a re-evaluation occurring at m-T3 determines the resources are no longer selectable, the new re-evaluation cut-off becomes m′-T3, e.g., as schematically illustrated in FIG. 13B and/or FIG. 6.3.2.2-2(b) in the 3GPP document TR 37.985, version 17.1.1.

Any embodiment, e.g. of the device 200 or 300, may perform SL communication transmission in case of handover, RLF and RRC reestablishment, e.g. using at least one of the features described hereinbelow.

As described in clause 5.8.8 of the 3GPP document TS 38.331, version 17.4.0, a UE capable of NR sidelink communication that is configured by upper layers to transmit NR sidelink communication and has related data to be transmitted shall:
1> if the conditions for NR sidelink communication operation as defined in 5.8.2 are met:
   2> if the frequency used for NR sidelink communication is included in FreqInfoToAddModList in sl-ConfigDedicatedNR within RRCReconfiguration message or included in sl-ConfigCommonNR within SIB12:
      3> if the UE is in RRC_CONNECTED and uses the frequency included in sl-ConfigDedicatedNR within RRCReconfiguration message:
         4> if the UE is configured with sl-ScheduledConfig:
         5> if T310 for MCG or T311 is running; and if sl-TxPoolExceptional is included in sl-FreqInfoList for the concerned frequency in SIB12 or included in sl-ConfigDedicatedNR in RRCReconfiguration; or
         5> if T301 is running and the cell on which the UE initiated RRC connection re-establishment provides SIB12 including sl-TxPoolExceptional for the concerned frequency; or
         5> if T304 for MCG is running and the UE is configured with sl-TxPoolExceptional included in sl-ConfigDedicatedNR for the concerned frequency in RRCReconfiguration:
         6> configure lower layers to perform the sidelink resource allocation mode 2 based on random selection using the pool of resources indicated by sl-TxPoolExceptional as defined in the 3GPP document TS 38.321, version 17.4.0;
         5> Else:
         6> configure lower layers to perform the sidelink resource allocation mode 1 for NR sidelink communication;
         5> if T311 is running, configure the lower layers to release the resources indicated by rrc-ConfiguredSidelinkGrant (if any);
         4> if the UE is configured with sl-UE-SelectedConfig:
         5> if a result of full/partial sensing, if selected and is allowed by sl-AllowedResourceSelectionConfig, on the resources configured in sl-TxPoolSelectedNormal for the concerned frequency included in sl-ConfigDedicatedNR within RRCReconfiguration is not available in accordance with the 3GPP document TS 38.214, version 17.5.0;
         6> if sl-TxPoolExceptional for the concerned frequency is included in RRCReconfiguration; or
         6> if the PCell provides SIB12 including sl-TxPoolExceptional in sl-FreqInfoList for the concerned frequency:
         7> configure lower layers to perform the sidelink resource allocation mode 2 based on random selection using the pool of resources indicated by sl-TxPoolExceptional as defined in the 3GPP document TS 38.321, version 17.4.0;
         5> else, if the sl-TxPoolSelectedNormal for the concerned frequency is included in the sl-ConfigDedicatedNR within RRCReconfiguration:
         6> configure lower layers to perform the sidelink resource allocation mode 2 based on resource selection operation according to sl-AllowedResourceSelectionConfig (as defined in the 3GPP document TS 38.321, version 17.4.0 and the 3GPP document TS 38.214, version 17.5.0) using the pools of resources indicated by sl-TxPoolSelectedNormal for the concerned frequency;
      3> else:
         4> if the cell chosen for NR sidelink communication transmission provides SIB12:
         5> if SIB12 includes sl-TxPoolSelectedNormal for the concerned frequency, and a result of full/partial sensing, if selected and is allowed by sl-AllowedResourceSelectionConfig, on the resources configured in the sl-TxPoolSelectedNormal is available in accordance with the 3GPP document TS 38.214, version 17.5.0 or random selection, if allowed by sl-AllowedResourceSelectionConfig, is selected:
         6> configure lower layers to perform the sidelink resource allocation mode 2 based on resource selection operation according to sl-AllowedResourceSelectionConfig using the pools of resources indicated by sl-TxPoolSelectedNormal for the concerned frequency as defined in the 3GPP document TS 38.321, version 17.4.0;
         5> else if SIB12 includes sl-TxPoolExceptional for the concerned frequency:
         6> from the moment the UE initiates RRC connection establishment or RRC connection resume, until receiving an RRCReconfiguration including sl-ConfigDedicatedNR, or receiving an RRCRelease or an RRCReject; or
         6> if a result of full/partial sensing, if selected and is allowed by sl-AllowedResourceSelectionConfig, on the resources configured in sl-TxPoolSelectedNormal for the concerned frequency in SIB12 is not available in accordance with the 3GPP document TS 38.214, version 17.5.0:
         7> configure lower layers to perform the sidelink resource allocation mode 2 based on random selection (as defined in the 3GPP document TS 38.321, version 17.4.0) using the pool of resources indicated by sl-TxPoolExceptional for the concerned frequency;
   2> else:
      3> configure lower layers to perform the sidelink resource allocation mode 2 based on resource selection operation according to sl-AllowedResourceSelectionConfig (as defined in the 3GPP document TS 38.321, version 17.4.0 and the 3GPP document TS 38.214, version 17.5.0) using the pools of resources indicated by sl-TxPoolSelectedNormal in SidelinkPreconfigNR for the concerned frequency.

It is noted that the UE 200 or 300 may continue using resources configured in rrc-ConfiguredSidelinkGrant (while T310 is running) until it is released (i.e. until T310 has expired). The UE 200 or 300 does not use sidelink-configured grant type 2 resources while T310 is running.

Furthermore, it is noted that in case of RRC reconfiguration with synchronization, the UE 200 or 300 uses resources configured in rrc-ConfiguredSidelinkGrant (while T304 on the MCG is running) if provided by the target cell.

Moreover, it is noted that it is up to implementation of the UE 200 or 300 to determine, in accordance with the 3GPP document TS 38.321, version 17.4.0, which resource pool to use if multiple resource pools are configured, and which resource allocation scheme is used in the AS based on UE capability (for a UE in RRC_IDLE/RRC_INACTIVE) and the allowed resource schemes sl-AllowedResourceSelectionConfig in the resource pool configuration.

Moreover, it is noted that in case that the network 910 (e.g., the node 100) does not provide resource pools in SIB12, a UE 200, which is out of coverage, will be unable to obtain sidelink resources to send the first UL RRC message.

If configured to perform sidelink resource allocation mode 2, the UE capable of NR sidelink communication that is configured by upper layers to transmit NR sidelink communication shall perform resource selection operation according to sl-AllowedResourceSelectionConfig on all pools of resources which may be used for transmission of the sidelink control information and the corresponding data. The pools of resources are indicated by SidelinkPreconfigNR, sl-TxPoolSelectedNormal in sl-ConfigDedicatedNR, or sl-TxPoolSelectedNormal in SIB12 for the concerned frequency, as configured above.

Optionally, the RAN 910 (e.g., the node 100) may dynamically allocate resources to the UE 200 or 300 via the SL-RNTI on one or more PDCCHs for NR sidelink communication.

Alternatively or in addition, the RAN 910 (e.g., the node 100) may allocate sidelink resources to the UE 200 or 300 with two types of configured sidelink grants:
Type 1: The node 100 (e.g., RRC) may directly provide the configured sidelink grant only for NR sidelink communication.
Type 2: The node 100 (e.g., RRC) may define a periodicity of the configured sidelink grant while PDCCH may either signal and activate the configured sidelink grant, or deactivate it. The PDCCH may be addressed to SL-CS-RNTI for NR sidelink communication.

When a radio link failure (RLF, e.g., a beam failure, BF, or any physical layer problem) occurs on a master cell group (MCG), the UE 200 or 300 may continue using the configured sidelink grant Type 1 until initiation of the RRC connection re-establishment procedure (e.g., as specified in the 3GPP document TS 38.331, version 17.4.0). During handover (HO), the UE 200 or 300 may be provided with configured sidelink grants via a handover command (e.g., regardless of the type). If provided, the UE 200 or 300 activates the configured sidelink grant Type 1 upon reception of the handover command or execution of a conditional handover (CHO).

Any embodiment of the technique may use at least one of the following observations (e.g. based on the above texts):
1. During RLF detection and recovery, RRC re-establishment and handover (HO), the UE 200 or 300 may use the sidelink (SL) resource allocation mode 2 (e.g., UE 200 or 300 autonomously selects SL resources from a SL resource pool) based on random selection using the exceptional pool of concerned SL frequency, to perform sidelink transmission and reception.
2. In addition, during HO, the UE 200 or 300 may perform SL transmission and/or SL reception based on configured sidelink grant Type 1 and/or a reception resource pool of the target cell as provided in the handover command.
3. In addition, during RLF detection and recovery (e.g. if T310 is running), the UE 200 or 300 cannot use Type 2 grant for resource configuration but can use configured grant Type 1 in the serving cell.

Based on above observations, at least some embodiments can reduce an interruption to SL communication during handover, RLF and/or RRC reestablishment.

Any embodiment may use SL-based positioning, e.g. according to future 3GPP Release 18. In 3GPP Release 18, SL positioning is being standardized, based on the Work Item Description (WID) in RP-230328. The SL positioning is to be standardized for all coverage scenarios, e.g. including in-coverage, partial coverage, and out-of-coverage (e.g. as illustrated in FIGS. 9A to 9C, respectively).

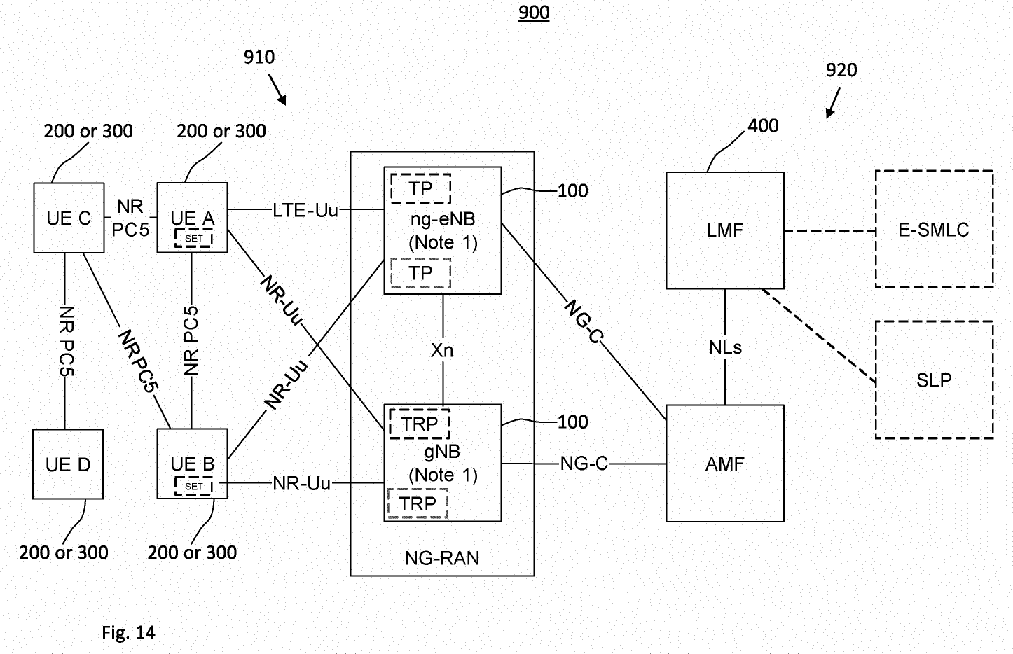

An example of an architecture of the network 900 including the RAN 910 and a core network 920, is a baseline architecture for SL positioning is schematically shown in FIG. 14. At least some embodiments achieve a deterministic and/or robust SL positioning procedure in the presence of distortions causing a degradation (e.g., delay, interruption, or outage) of SL position resource allocation at the at least one radio device (UE) 200 or 300 among the involved radio devices (UEs).

Conventional UE behavior with respect to SL positioning operation is unspecified during handover, RAN link failure/recovery procedures, etc. Furthermore, there can be performance degradation in SL positioning during such scenarios, which is currently uncontrolled.

For SL positioning, depending on network coverage status of a target UE 200 (i.e., in coverage or out of coverage), a positioning procedure (e.g., a positioning session) may involve the target UE 200, one or multiple reference UEs 300 (also referred to as anchor UEs 300), and/or a positioning server 400 (a UE or an LMF in the network). Any UE 200 or 300 (e.g., receiving or transmitting a sidelink positioning reference signal, SL PRS) in a positioning session (i.e., during the SL positioning procedure) may experience handover, RLF or RRC reestablishment in the Uu connection to the gNB 100 (which are examples of the distortion).

Conventionally, this may cause interruption to the SL transmissions and/or SL receptions between this UE 200 or 300 and one or more other UEs 300 or 200 in the same positioning session. For example, the SL positioning resources in the serving cell may become unavailable during the interruption period. In this case, the affected UEs 200 and/or 300 in the positioning session may be conventionally unable to provide the measurement results to the LMF 400 or the positioning server 400 (e.g., in the UE 200 or 300), which may lead to a ranging failure and/or a positioning failure.

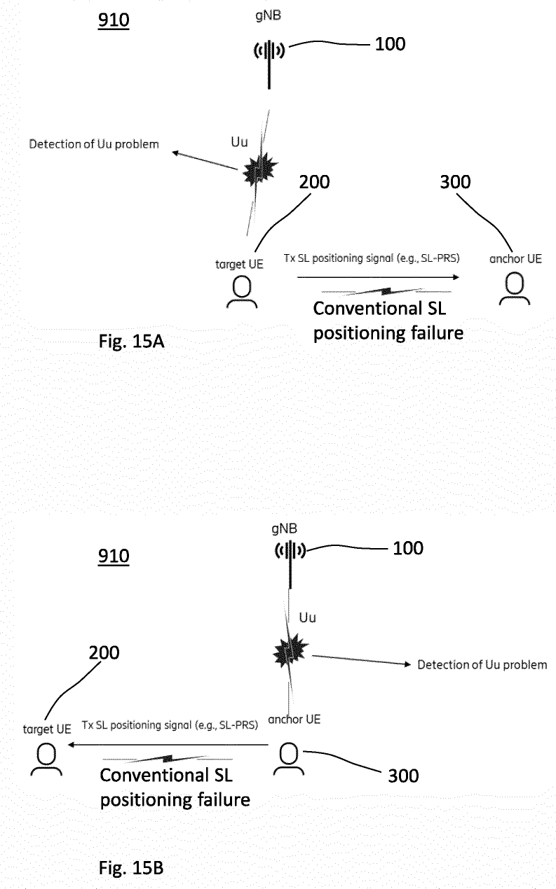

Two examples of the conventional issues are illustrated in the FIGS. 15A and 15B, respectively.

FIG. 15A schematically illustrates a target UE 200 experiencing radio problem on its Uu link in a SL positioning session.

In one example, which may be applied to the case illustrated in FIG. 15A and/or FIG. 15B, the target UE 200 is transmitting SL positioning signal towards one anchor UE 300, which measures the received SL positioning signal. The anchor UE 300 may provide the measurement results to the LMF 400 or the positioning server UE 400 where the position (e.g., location) of the target UE 200 may be determined (e.g., estimated) based on the positioning measurement results provided by the anchor UE 300.

When the target UE 200 has detected radio problem on its Uu link (e.g., meaning that the target UE 200 may be soon and/or likely to change to a different serving cell), the current SL positioning resources, which the target UE 200 applies, may become unavailable, which would conventionally cause an interruption to the on-going positioning session.

FIG. 15B schematically illustrates an anchor UE 300 experiencing radio problem on its Uu link in a SL positioning session.

In another example, which may be applied to the case illustrated in FIG. 15A and/or FIG. 15B, the anchor UE 300 is transmitting SL positioning signal towards the target UE, which measures the received SL positioning signal. The target UE 200 may provide the measurement results to the LMF 400 or the positioning server 400 (e.g., in the UE 200 or 300) where the target UE's location can be estimated based on the positioning measurement results provided by the target UE 200.

When the anchor UE 300 has detected radio problem on its Uu link (e.g., meaning that the anchor UE 300 may be likely to change to a different serving cell), the current SL positioning resources, which the anchor UE 300 applies, may become unavailable, which would conventionally cause an interruption to the on-going positioning session.

Embodiments of the technique can prevent at least some of these interruptions.

The embodiments herein enable handling one or more distortions during an SL positioning session. The distortions may be due to events associated with a RAN connection, e.g., a serving cell change, a handover, a radio resource control (RRC) configuration (e.g., an RRC reconfiguration), a radio link failure (RLF, e.g. a beam failure), etc.

Embodiments of the method 500, 600, 700 or 800 for any aspect of the technique may comprises at least one of the following general steps in a node 100, 200, 300 and/or 400. For brevity and not limitation, below steps are referred to using the reference signs of the first method aspect 500. The node may be, or may be embodied by, at least one of the target UE 200, the reference UE 300, the positioning server 400 in the UE 200 or 300, the positioning server 400 in the network 900 (e.g., in the RAN 910 or the CN 920), and a radio network node 100 (e.g., an eNB or gNB).

A step 502 of the method 500 may comprise: The node (e.g., target UE, reference UE, positioning server in a UE, positioning server in the network, radio network node, gNB, etc.) obtains information related to a (e.g., at least one) distortion of a Uu link (e.g., uplink and/or downlink) at one or more UEs during a SL positioning session. The distortion is associated with at least one distorting event at the reference UE or another UE (e.g., the target UE) which is involved in the same SL positioning session. Examples of the event may include: RAN connection failure (e.g., RLF or BF), cell change (e.g., serving cell change, PCell change, PSCell change, handover, etc.), radio link (re)establishment, RRC (re)establishment, poor radio link quality or radio link failure (RLF), etc.

A step 504 of the method 500 may comprise: The obtained information can then be used by the node for performing one or more of actions in order to handle the distortion during the SL positioning session

In some but not necessarily all examples, a step 506 may comprise: The node can in response to its one or more actions receive a message from another node (UE or network node), in relation to handling the distortion.

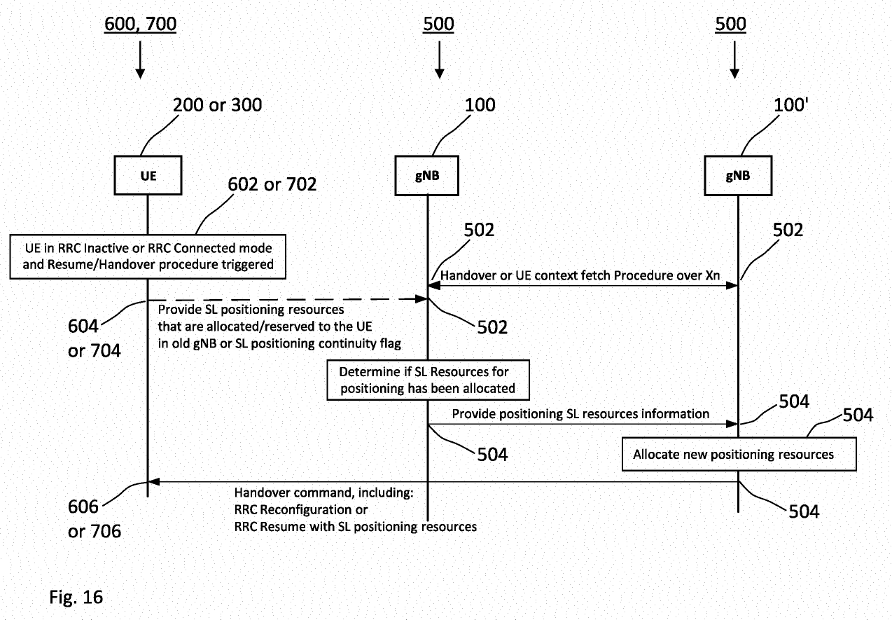

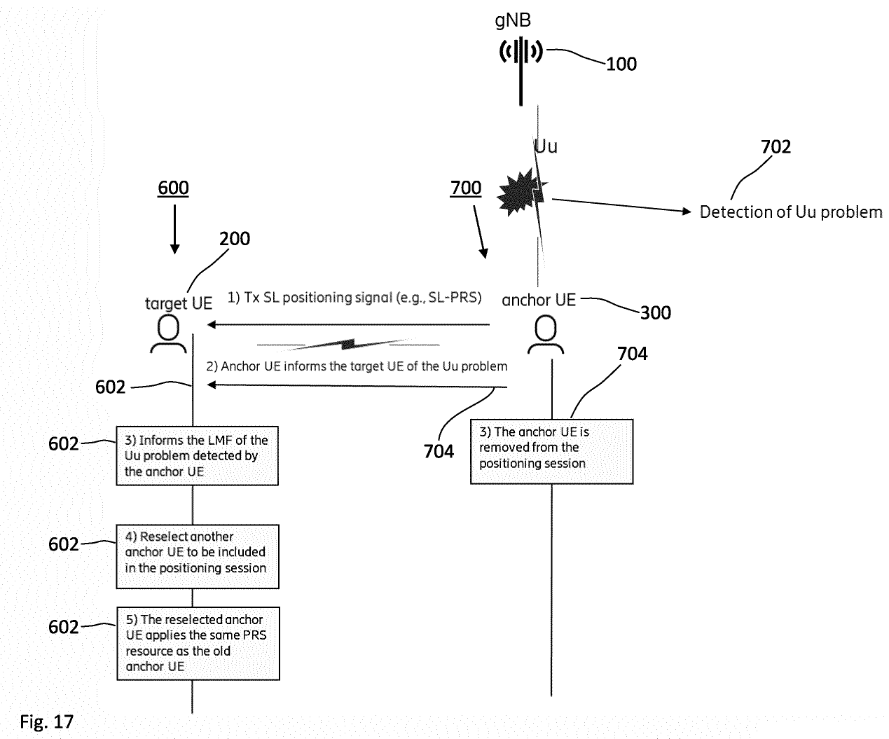

Non-limiting examples are provided below, partly with reference to FIGS. 16 and 17.

Example 1 may provide one solution to achieve continuity for the on-going SL positioning session. FIG. 16 shows a flowchart for an embodiment of the methods 500, 600, 700 and/or 800 to keep the UE 200 or 300, which is experiencing the Uu problem, in the positioning session.

Precondition:
UE in RRC Inactive state and UE Context fetch procedure has been initiated while has ongoing allocated SL positioning resources or
UE in RRC Connected mode and Handover procedure has been initiated while has ongoing allocated SL positioning resources

Exemplary method steps:
UE in RRC Resume Request indicates that SL Positioning is ongoing, and resources have been allocated
UE in Measurement Report when certain event for HO or Conditional Handover is fulfilled indicates (for example in RRC Establishment setup complete for CHO case) that there is also an ongoing SL positioning operation ongoing, and it wants to continue in new cell/gNB
Old gNB provides the dimension of allocated SL positioning resources
New gNB allocates the new SL positioning resources

Example 2, which may be combined with Example 1, comprises exchanging of the information on Uu radio problem, e.g. according to the step 502, 602, 702, or 802.

The distortion may be a Uu problem.

New signaling is introduced to enable a target UE 200 to signal the LMF 400 or the positioning server UE 400 that the target UE 200 is experiencing the distortion (e.g., a radio problem, such as an RLF, an RRC reestablishment or a handover) on its Uu connection so that the on-going SL positioning session may be interrupted due to unavailability of the SL PRS resources in the current serving cell.

Alternatively or in addition, new signaling is introduced to enable a reference UE 300 to signal the LMF 400 or the positioning server UE 400 that the reference UE 300 is experiencing the Uu problem (e.g., RLF, RRC reestablishment or handover on its Uu connection) so that the reference UE 300 may not obtain the required positioning measurements within the required time period.

Upon detection that a reference UE 300 is experiencing the Uu problem (e.g., RLF, RRC reestablishment or handover) on its Uu connection, it is determined by the target UE 200, the LMF 400 or the positioning server UE 400 whether the reference UE 300 is continuing to be kept in the positioning session, or another reference UE needs to be selected to replace the reference UE.

Mobility status reflecting whether a reference UE candidate is experiencing or likely to experience RLF, RRC reestablishment or handover is considered by the target UE, the LMF or the positioning server UE to determine this reference UE candidate UE can be selected as a reference UE to provide positioning measurements/assistance for the target UE.

If it is determined to select another anchor UE 300 to replace the anchor UE 300 which has the Uu problem. In order to minimize the potential interruption due to change of the anchor UE, the new selected anchor UE 300 may use the same SL positioning resources which were allocated to the old anchor UE if it is feasible. for instance, both anchor UEs are accessing the same SL carrier and the same positioning resource pools.

In order to configure and/or inform the new (i.e., replacing) anchor UE 300 of the SL positioning resources (e.g., which are the same as the ones allocated and/or reserved to the old (i.e., replaced) anchor UE), at least one of the following signaling options may be applied.
Option 1: the target Ue 200 signals the new anchor Ue 300 of those resources via Pc5 RRC signaling, MAC CE etc.
Option 2: The gNB 100 of the old anchor UE 300 signals those resources to the gNB of the new anchor UE. The gNB of the new anchor UE further signals those resources to the new anchor UE 300 via Uu RRC signaling, MAC CE.
Option 3: The LMF 400 signals those resources to the new anchor UE 300 via NR Positioning Protocol A (NPPa) signaling and/or LTE Positioning Protocol (LPP) signaling

Example 3, which may be combined with Example 1 or 2, transmits or receives a HO command (e.g., as an example of the action). The HO command comprises SL positioning resource configuration in the target cell
using a handover command to provide SL positioning resource configuration to the SL UE 200 or 300
   In an example, a RRC reconfiguration (e.g. with synchronization), may comprise one or multiple SL TX or RX positioning resource pools containing SL positioning resources associated with the concerned SL carriers. The target network node or target cell may be configured with one or multiple SL carriers. Each SL carrier may be configured with one or multiple positioning TX resource pools and one or multiple positioning RX resource pools.
   As another example, among the positioning resource pools configured in the target cell, there is at least one positioning resource pool which is dedicated for SL positioning purpose.
   As yet another example, among the positioning resource pools configured in the target cell, there is at least one positioning resource pool which is used for both SL positioning and SL communication.

Example 4, which may be combined with any of examples 1 to 3, comprises a step of determining and/or using the information about the amount of interruption (e.g., as an action).

A node (i.e., any one of the device 100, 200, 300 or 400) determines an amount of interruption (e.g., experienced or allowed) and performs at least one operation, based on or adaptively to the determined amount of interruption, e.g., perform an SL positioning measurement and/or inform another node (UE or network node) about the determined amount of interruption. The receiving node can use this information, e.g., when processing the SL positioning measurements, determining location, for providing assistance data for SL positioning, for configuring at least one parameter (in the receiving node or another node) related to SL positioning, etc.

Example 5, which may be combined with any of examples 1 to 4, comprises a step of controlling the distorting event (e.g., as an action).

The node can, based on the obtained information related to the distortion, perform an action impacting or controlling the distorting event (e.g., handover, cell change, connection (re)configuration or (re)establishment, RLF, etc.), e.g., delay, stop, or (re)configuring the distorting event (e.g., to reduce, avoid, or compensate the impact on SL positioning session), etc.

Exemplary detailed embodiments are described hereinbelow. Any of these embodiments may be implemented as disclosed or in combination with any of the examples above or any embodiment in the below list of embodiments.

The embodiments are described in the context of NR, i.e., target UE and reference/assisting UE are deployed in a same or different NR cells. The link between a target UE and an assisting UE may be based on LTE sidelink, NR sidelink or any other short-range communication technology such as Wi-Fi. The Uu connection between the network (e.g., base station) and target UE or the reference UE may be based on any radio access network, e.g., LTE Uu or NR Uu.

The terms location server, positioning server, positioning node, Location Management Function (LMF), Evolved Serving Mobile Location Center (E-SMLC), Secure User Plane Location node (SUPL node) can be used inter-changeably, at least in some examples. In some examples, the positioning server can be comprised in a UE; in other examples, the positioning server can be comprised in the network; in yet other examples, positioning server can be a user-plane positioning server (e.g., SUPL node).

Herein, a target UE is the UE whose location is to be determined by means of SL positioning. There can also be a group of target UE(s), e.g., in group positioning when location of the group of UEs is to be determined. Target UE may receive and/or transmit radio signals for SL positioning. In some examples, target UE may perform SL measurements for SL positioning. The embodiments are described for a single UE, but can also be applied or adapted for SL positioning of a group of UEs.

Herein, the terms reference UE or assisting UE or anchor UE can be used interchangeably, at least in some embodiments, and refer to UE assisting in SL positioning of a target UE, e.g., by performing one or more of: transmitting SL radio signals for SL positioning of the target UE, receiving SL radio signals for SL positioning of the target UE, performing SL measurements for SL positioning of the target UE, providing assistance data to assist in transmitting and/or receiving SL radio signals for SL positioning of the target UE or for performing SL measurements for SL positioning of the target UE.

The term time resource (which may be an example of the SL positioning resources) used herein may correspond to any type of physical resource or radio resource expressed in terms of length of time. Examples of time resources include: a symbol (e.g., an Orthogonal Frequency Division Multiplexing, OFDM, symbol), a time slot, a subframe, a radio frame, a transmission time interval (TTI), an interleaving time, a slot, a sub-slot, a mini-slot, etc.

SL positioning may comprise a positioning procedure (e.g., a positioning session). Depending on network coverage status of the target UE (e.g., being in coverage or being out of coverage), the SL positioning may involve at least one of: the target UE, one or multiple reference UEs (also referred to as anchor UEs), a positioning server UE, and an LMF. It may be also feasible that multiple target UEs 200 are involved in the same positioning session. These target UEs 200 can obtain positioning measurements (e.g., positioning estimation) in the same positioning session. A positioning session may be setup for a target UE based on a positioning request (e.g., a location request) triggered by the target UE itself (e.g., referred to as a mobile-originated location request, MO-LR, procedure) or by a network entity (e.g., referred to as a mobile-terminated location request, MT-LR, procedure).

A SL positioning resource refers to a time-frequency resource within a time duration of a SL resource pool that is used for SL positioning transmission. Characteristics associated with a SL positioning resource include at least one of:
SL positioning resource ID,
SL positioning resource starting symbol and number of SL symbols occupied by the positioning resource,
SL positioning resource frequency domain allocation,

A SL positioning resource is identified by a SL positioning resource ID.

A SL positioning resource refers to resources occupied by a SL positioning reference signal (PRS).

A first aspect relates to embodiments in a radio network node 100 (e.g., gNB 100).

Exemplary step 502: According to this part of the method 500, a radio network node (e.g., gNB) obtains information related to distortion(s) at one or more UE(s) during SL positioning session, wherein the distortion is associated with at least one distorting event of a Uu link at the same or different UE which is involved in the same SL positioning session: RAN connection, cell change (e.g., serving cell change, Pcell change, PSCell change, handover, etc.), radio link (re)establishment, RRC (re)establishment, poor radio link quality or radio link failure, etc.
The one or more UEs can comprise at least one of: reference UE and/or target UE.
The distortion(s) can comprise any or more of: interruption in radio signal transmission for SL positioning, interruption in radio signal reception or detection for SL positioning, distortion in SL measurement for SL positioning, distortion in SL measurement reporting, distortion in assistance data provisioning, distortion in any SL positioning related procedure during the SL positioning session, etc. The distortion can be the current distortion or future distortion.
Obtaining the information can further comprise, e.g.:
   receiving the information from another node and/or determining a distortion based on a message from another node (e.g., UE, a network node, positioning node, another radio network node, a serving cell, a neighbor cell, source cell at handover, target cell at handover, etc.), and/or
   Performing or obtaining a measurement result (e.g., Uu radio signal reception/detection/measurement or measurement attempt, mobility measurements, etc.).

One specific example of the message is a handover-related message or handover command.
the information can comprise, e.g.:
   an indication that the distorting event is taking place, will be taking place, may take place, or likely to take place,
   an indication that the distorting event is over or will be over soon or that the one or more UEs have recovered from the distorting event,
   type of the distorting event,
   implicit or explicit indication of the duration of the distorting event,
   at least one configuration parameter for SL positioning in relation to the distorting event (e.g., SL positioning resource configuration, SL positioning resource pool to be used during handover, SL positioning resource configuration used before the event to enable configuring SL positioning resource configuration in a new cell, SL positioning resource configuration to be used after the event, etc.),
   a measurement result (e.g., a mobility measurement, RRM measurement, SL measurement, SL positioning measurement, DL measurement, UL measurement, etc.).

Exemplary step 504: The radio network node 100, based on the obtained information related to the distortion, may perform one or more of actions in order to handle the distortion during the SL positioning session:
inform at least one other UE in the same SL positioning session about the distortion at the one or more UEs (the information contents can be similar to that described for Step 502, see also embodiments for target UE and reference UE),
inform another radio network node (e.g., another gNB) (the information contents can be similar to that described for Step 502), which may also act upon receiving this information,
inform a positioning server (e.g., in a UE or in a network node) (the information contents can be similar to that described for Step 502), which may then perform an action based on the received information-see more details in the embodiments for positioning server
provide assistance data to one or more UEs in the same SL positioning session,
determine and/or (re)select one or more reference UEs for the SL positioning session,
perform an action impacting or controlling the distorting event (e.g., handover, cell change, connection (re)configuration or (re)establishment, RLF, etc.), e.g., delay, stop, or (re)configuring the distorting event (e.g., to reduce, avoid, or compensate the impact on SL positioning session), etc.
perform, control, adapt, instruct, recommend, or (re)configure at least one of: SL measurements, SL positioning measurement(s), radio signal transmission(s) and/or reception for SL positioning, SL positioning session, etc. which may further comprise e.g. any of:
   configuring a new or an extended duration, extended or additional number of samples or number of transmissions, periodicity, configuring additional transmission/reception occasions to compensate for distortion,
   instructing to perform an action in relation to the distortion (e.g., stop/drop/restart/pause/resume/continue/delay/postpone a measurement, measurement procedure, or individual samples for SL positioning, start/stop/pause/resume transmitting SL PRS, etc.),
   determining a measurement period associated with the distorting event and perform at least one SL positioning measurement based on the determined measurement period (the determined measurement period can be different from that without the distorting event),
   determining an amount of interruption (e.g., an actual or experienced amount of interruption, an allowed amount of interruption, a maximum duration of interruption, number of interrupted time resources, number of dropped or non-available samples due to the distortion, etc.) for at least one operation for SL positioning (e.g., measurement, transmission, measurement processing, selection of reference UE(s), determining time and/or frequency resources for SL positioning, detection/determining the presence of SL PRS, setting up and/or configuring SL positioning session, etc.) and perform one or both, based on the determined allowed amount of interruption:
      perform the corresponding operation adaptively to the determined amount of interruption (e.g., reduce, avoid, remove, or compensate the impact of the distorting event; the operation may e.g. be delayed or postponed for the same reason, use or rely on a specific set of resources and/or signals for the same reason, etc.), and/or
      inform implicitly or explicitly another node (e.g., UE or network node) about the determined amount of interruption (the receiving node can use this information, e.g., when performing an SL positioning measurement, processing the SL positioning measurements, determining location, for providing assistance data for SL positioning, for configuring at least one parameter (in the receiving node or another node) related to SL positioning, etc.).

Receiving the information in Step 502 or informing another node in Step 504 can be, e.g., via L1, L2, and/or L3 signaling; unicast, multicast, or broadcast, directly or via yet another node. Some examples are an RRC message, handover-related message or command, positioning protocol, LPP, LPPe, SL positioning protocol, SUPL, system information, X2, X3, message via SL interface or PC5, etc.

Optional step 506 (in some examples): The radio network node 100 may further receive a message in response to its action, e.g., confirmation, acknowledgement, a configuration related to handling the distortion, result of an operation triggered by and/or based on its action, etc.

Below are some more specific examples, based on the steps described above:
using a handover command to provide SL positioning resource configuration to the SL UE
   in an example, a RRC reconfiguration with sync, may comprise one or multiple SL TX or RX positioning resource pools containing SL positioning resources associated with the concerned SL carriers. The target cell may be configured with one or multiple SL carriers wherein each SL carrier is configured with one or multiple positioning TX resource pools and one or multiple positioning RX resource pools.
   As another example, among the positioning resource pools configured in the target cell, there is at least one positioning resource pool is dedicated for SL positioning purpose.
   As yet another example, among the positioning resource pools configured in the target cell, there is at least one positioning resource pool is used for both SL positioning and SL communication.
Using a RRCReestablishment message which is triggered in case of RRC Reestablishment to provide one or multiple SL positioning resource pools associated with one or multiple SL carriers in the selected cell.
Using a NRPPa signaling message to provide one detected distortion event (e.g., Uu RLF or handover) associated with a target UE to the positioning server

A second aspect relates to embodiments on a target UE 300.

This group or aspect covers various embodiments on how a target UE 300 can handle interruptions during the on-going SL positioning session due to e.g. handover, RLF or RRC reestablishment occurred for a UE involved in the same positioning session, e.g., for target UE(s) or any reference UE.

Exemplary step 602: According to this part of the method 600, a target UE 300 obtains information related to distortion(s) at one or more UE(s) during SL positioning session, wherein the distortion is associated with at least one distorting event of a Uu link at the reference UE or another UE which is involved in the same SL positioning session: RAN connection, cell change (e.g., serving cell change, Pcell change, PSCell change, handover, etc.), radio link (re)establishment, RRC (re)establishment, poor radio link quality or radio link failure, RLF, etc.
The one or more UEs can comprise at least one of: reference UE and/or target UE.
The distortion(s) can comprise any or more of: interruption in radio signal transmission for SL positioning, interruption in radio signal reception or detection for SL positioning, distortion in SL measurement for SL positioning, distortion in SL measurement reporting, distortion in assistance data provisioning, distortion in any SL positioning related procedure during the SL positioning session, etc. The distortion can be the current distortion or future distortion.
Obtaining the information can further comprise, e.g.:
   receiving the information from another node and/or determining a distortion based on a message from another node (e.g., another UE, another network node, radio network node, a serving cell, a neighbor cell, source cell at handover, target cell at handover, etc.),
   Performing or obtaining a measurement result (e.g., SL radio signal reception/detection/measurement or measurement attempt, mobility measurements, etc.).,
The information can comprise, e.g.:
   an indication that the distorting event is taking place, will be taking place, may take place, or likely to take place,
   an indication that the distorting event is over or will be over soon or that the one or more UEs have recovered from the distorting event,
   type of the distorting event,
   implicit or explicit indication of the duration of the distorting event,
   at least one configuration parameter for SL positioning in relation to the distorting event (e.g., SL positioning resource configuration, SL positioning resource pool to be used during handover, SL positioning resource configuration used before the event to enable configuring SL positioning resource configuration in a new cell, SL positioning resource configuration to be used after the event, etc.),
   a measurement result (e.g., a mobility measurement, RRM measurement, SL measurement, SL positioning measurement, DL measurement, UL measurement, etc.).

Exemplary step 602: The target UE 200, based on the obtained information related to the distortion, may perform one or more of actions in order to handle the distortion during the SL positioning session:
inform at least one other UE (another target UE or reference UE) in the same SL positioning session about the distortion at the one or more UEs (the information contents can be similar to that described for Step 602, see also embodiments for target UE),

inform a radio network node, e.g., gNB (the information contents can be similar to that described for Step 602, see also embodiments for the radio network node),
inform positioning server, e.g., in a UE or in a network node (the information contents can be similar to that described for Step 602, see also embodiments for positioning server),
provide assistance data to one or more UEs in the same SL positioning session,
determine and/or (re)select one or more reference UEs for the SL positioning session,
perform an action impacting or controlling the distorting event (e.g., handover, cell change, connection (re)configuration or (re)establishment, RLF, etc.), e.g., delay, stop, or (re)configuring the distorting event (e.g., to reduce, avoid, or compensate the impact on SL positioning session), etc.
perform, control, adapt, instruct, recommend, or (re)configure at least one of: SL measurements, SL positioning measurement(s), radio signal transmission(s) and/or reception for SL positioning, SL positioning session, etc. which may further comprise e.g. any of:
   configuring a new or an extended duration, extended or additional number of samples or number of transmissions, periodicity, configuring additional transmission/reception occasions to compensate for distortion,
   instructing to perform an action in relation to the distortion (e.g., stop/drop/restart/pause/resume/continue/delay/postpone a measurement, measurement procedure, or individual samples for SL positioning, start/stop/pause/resume transmitting SL PRS, etc.),
   determining a measurement period associated with the distorting event and perform at least one SL positioning measurement based on the determined measurement period (the determined measurement period can be different from that without the distorting event),
   determining an amount of interruption (e.g., an actual or experienced amount of interruption, an allowed amount of interruption, a maximum duration of interruption, number of interrupted time resources, number of dropped or non-available samples due to the distortion, etc.) for at least one operation for SL positioning (e.g., measurement, transmission, measurement processing, selection of reference UE(s), determining time and/or frequency resources for SL positioning, detection/determining the presence of SL PRS, setting up and/or configuring SL positioning session, etc.) and perform one or both, based on the determined allowed amount of interruption:
      perform the corresponding operation adaptively to the determined amount of interruption (e.g., reduce, avoid, remove, or compensate the impact of the distorting event; the operation may e.g. be delayed or postponed for the same reason, use or rely on a specific set of resources and/or signals for the same reason, etc.), and/or
      inform implicitly or explicitly another node (e.g., UE or network node) about the determined amount of interruption (the receiving node can use this information, e.g., when performing an SL positioning measurement, processing the SL positioning measurements, determining location, for providing assistance data for SL positioning, for configuring at least one parameter (in the receiving node or another node) related to SL positioning, etc.).
report a measurement together with an indication of whether the distorting event occurred during the measurement period and/or the time and/or frequency resources used for the measurement performed during the SL positioning session with the one or more distorted events.

Receiving the information in Step 602 or informing another node in Step 604 can be, e.g., via L1, L2, and/or L3 signaling; unicast, multicast, or broadcast, directly or via yet another node. Some examples are an RRC message, handover-related message or command, positioning protocol, LPP, LPPe, SL positioning protocol, SUPL, system information, X2, X3, message via SL interface or PC5, etc.

Optional step 606 (in some examples): The target UE 200 may further receive a message in response to its action, e.g., confirmation, acknowledgement, result of an operation triggered by and/or based on its action, a configuration related to handling the distortion, measurement (re)configuration, SL PRS reconfiguration, etc.
1) Below are some more specific examples, based on the steps described above: In one embodiment, a target UE may select a reference UE for the SL positioning session according to the mobility status of this reference UE. The mobility status of a reference UE may comprise at least one of the below information
   Whether the reference UE is experiencing or likely to experience radio link failure.
   Whether the reference UE is experiencing or likely to experience RRC reestablishment.
   Whether the reference UE is experiencing or likely to experience handover.
For any one of the above mobility status, the status is measured for the reference UE in terms of its radio channel quality towards its serving gNB
   including radio metrics for example RSRP, RSRQ, RSSI, SINR, SIR etc. Higher value the measurement is, better radio channel quality the connection shows,
   Including congestion metrics for example channel busy ratio, channel usage radio, channel occupancy, BLER etc. higher value the measurement is, worse radio channel quality the connection shows.
   The UE selects the reference UE with strongest radio channel quality among the neighbor UEs.
   The UE selects the reference UE which is less likely to experience radio link failure, RRC reestablishment and handover within a time period (e.g., the required period to obtain positioning/location estimation for the target UE).
   The UE doesn't select a UE which is experiencing RLF, RRC reestablishment and handover as a reference UE.
   How likely a reference UE may experience RLF, RRC establishment and handover is measured by the target UE via at least one of the below options:
      Option 1: Based on the measured Uu radio channel quality of the reference UE. The reference UE may indicate/signal its Uu radio channel quality to the target UE
      Option 2: The reference UE signals the target UE of whether the reference UE is experiencing or likely to experience RLF, RRC reestablishment or handover.
2) In one embodiment, upon reception of a signaling from a reference UE (which is already selected by the target UE) indicating that the reference UE is experiencing or likely to experiencing RLF, RRC reestablishment or handover, the target UE may apply one of the below options to handle this reference UE
   Option 1: reselect another reference UE to join the positioning session to replace the reference UE
   Option 2: keeping this reference UE based on an assumption that the reference UE will recover from its current bad radio channel condition soon.
   Alternatively, the target UE may receive a second signaling from the reference UE indicating whether the reference UE has recovered from the bad radio connection condition, i.e., whether the reference UE has recovered from RLF, whether the reference UE has reestablished its RRC connection successfully, or whether the reference UE has completed handover successfully. Based on reception of the second signaling, the target UE 200 can further determine whether to reselect another reference UE 300 or keep this reference UE in the positioning session.
   Further, the target UE 200 may further send signaling to the LMF or the positioning server UE. The signaling carries the information received from the reference UE and the decision of the target UE, i.e., whether to reselect another reference UE or keep this reference UE 300.
   As a further embodiment, the target UE 200 may decide not to reselect another reference UE to replace the reference UE 300 which is in bad radio channel condition (e.g., experiencing RLF, RRC reestablishment or handover). Instead, the target UE may attempt to obtain additional positioning measurements from the rest reference UEs. These additional positioning measurements may compensate the loss of positioning measurements due to removal of the reference UE which is in bad radio channel condition. However, additional positioning measurements may result into additional positioning latency, which may be acceptable given the remaining latency budget of the positioning session/request may be still sufficient long to allow additional positioning measurements.
   As a further embodiment, the target UE chooses the option according to the signaling or configuration received from the gNB, the LMF or the positioning server UE 400.
   As a further embodiment, the target UE 200 chooses the option according to its implementation.
3) In one embodiment, the target UE is experiencing or likely to experiencing RLF, RRC reestablishment or handover according to the measurements of same metrics as for the reference UE (as described in previous embodiments). The target UE may signal this to its reference UEs, LMF or the positioning server UE.
4) In one embodiment, the target UE is experiencing RLF, RRC reestablishment or handover according to the measurements of same metrics as for the reference UE (as described in previous embodiments). As a result, the target UE may have to switch to SL positioning resources in a target cell, since the SL positioning resource in the serving cell may become unavailable. In this case, the target UE 200 may need to inform other reference UEs 300 of the new SL positioning resources which the target UE is going to use during the rest positioning session.
5) In one embodiment, due to detection of RLF, RRC reestablishment or handover by the target UE or any reference UE, the target UE may signal the LMF or the positioning server UE that the required positioning measurements may not be able to be obtained within the required time. The signaling also comprises a cause indicating the reason why the required positioning measurements cannot be obtained during the required time.

FIG. 17 schematically illustrates an example of a replacement of the anchor UE 300, which has Uu problem, with another anchor UE 300 in the positioning session. In other words, an example of the mechanism is illustrated in FIG. 17.

In FIG. 17, one anchor UE 300 has detected Uu problem. The anchor UE 300 informs this to the target UE. Upon reception of the information, the target UE may further inform the LMF of the issue, i.e., the anchor UE is experiencing Uu problem, which may result in an interruption to the on-going positioning session.

It is determined to select another anchor UE to replace the anchor UE which has Uu problem. In order to minimize the potential interruption due to change of the anchor UE, the new selected anchor UE may use the same SL positioning resources which were allocated to the old anchor UE 300.

In order to configure/inform the new anchor UE of the SL positioning resources (e.g., which are the same as the ones allocated/reserved to the old anchor UE), the following signaling options can be applied.
Option 1: the target Ue 200 signals the new anchor Ue of those resources via Pc5 Rrc signaling, MAC CE etc.
Option 2: The gNB 100 of the old anchor UE signals those resources to the gNB of the new anchor UE. The gNB of the new anchor UE further signals those resources to the new anchor UE via Uu RRC signaling, MAC CE.
Option 3: The LMF 400 signals those resources to the new anchor UE by means of NPPa signaling or LPP signaling

A third aspect relates to embodiments on a reference UE 300.

Exemplary step 702: According to this part of the method 700, a reference UE 300 obtains information related to one or more distortions at one or more UEs (e.g., 200 or 300) during SL positioning session, wherein the distortion is associated with at least one distorting event of a Uu link at the reference UE 300 or another UE which is involved in the same SL positioning session: RAN connection, cell change (e.g., serving cell change, PCell change, PSCell change, handover, etc.), radio link (re)establishment, RRC (re)establishment, poor radio link quality or radio link failure, etc.
The one or more Ues can comprise at least one of: reference Ue and/or target Ue.
The distortion(s) can comprise any or more of: interruption in radio signal transmission for SL positioning, interruption in radio signal reception or detection for SL positioning, distortion in SL measurement for SL positioning, distortion in SL measurement reporting, distortion in assistance data provisioning, distortion in any SL positioning related procedure during the SL positioning session, etc. The distortion can be the current distortion or future distortion.
Obtaining the information can further comprise, e.g.:
   receiving the information from another node and/or determining a distortion based on a message from another node (e.g., another UE, another network node, radio network node, a serving cell, a neighbor cell, source cell at handover, target cell at handover, etc.),
   Performing or obtaining a measurement result (e.g., SL radio signal reception/detection/measurement or measurement attempt, mobility measurements, etc.).,
The information can comprise, e.g.:
   an indication that the distorting event is taking place, will be taking place, may take place, or likely to take place,
   an indication that the distorting event is over or will be over soon or that the one or more UEs have recovered from the distorting event,
   type of the distorting event (as an example of the radio protocol event),
   implicit or explicit indication of the duration of the distorting event,
   at least one configuration parameter for SL positioning in relation to the distorting event (e.g., SL positioning resource configuration, SL positioning resource pool to be used during handover, SL positioning resource configuration used before the event to enable configuring SL positioning resource configuration in a new cell, SL positioning resource configuration to be used after the event, etc.),
   a measurement result (e.g., a mobility measurement, RRM measurement, SL measurement, SL positioning measurement, DL measurement, UL measurement, etc.).

Exemplary step 704: The reference UE 300, based on the obtained information related to the distortion, may perform one or more of actions in order to handle the distortion during the SL positioning session:
inform at least one other UE (target UE 200 or another reference UE 300) in the same SL positioning session about the distortion at the one or more UEs (the information contents can be similar to that described for Step 702, see also embodiments for target UE),
inform a radio network node 100, e.g., gNB 100 (the information contents can be similar to that described for Step 702, see also embodiments for the radio network node),
inform positioning server 400, e.g., in a UE 200 or 300 or in a network node 100 (the information contents can be similar to that described for Step 702, see also embodiments for positioning server),
provide assistance data to one or more UEs 200 or 300 in the same SL positioning session,
determine and/or (re)select one or more reference UEs 300 for the SL positioning session,
perform an action impacting or controlling the distorting event (e.g., handover, cell change, connection (re)configuration or (re)establishment, RLF, etc.), e.g., delay, stop, or (re)configuring the distorting event (e.g., to reduce, avoid, or compensate the impact on SL positioning session), etc.
perform, control, adapt, instruct, recommend, or (re)configure at least one of: SL measurements, SL positioning measurement(s), radio signal transmission(s) and/or reception for SL positioning, SL positioning session, etc. which may further comprise, e.g., any of:
   configuring a new or an extended duration, extended or additional number of samples or number of transmissions, periodicity, configuring additional transmission/reception occasions to compensate for distortion,
   instructing to perform an action in relation to the distortion (e.g., stop/drop/restart/pause/resume/continue/delay/postpone a measurement, measurement procedure, or individual samples for SL positioning, start/stop/pause/resume transmitting SL PRS, etc.),
   determining a measurement period associated with the distorting event and perform at least one SL positioning measurement based on the determined measurement period (the determined measurement period can be different from that without the distorting event),
   determining an amount of interruption (e.g., an actual or experienced amount of interruption, an allowed amount of interruption, a maximum duration of interruption, number of interrupted time resources, number of dropped or non-available samples due to the distortion, etc.) for at least one operation for SL positioning (e.g., measurement, transmission, measurement processing, selection of reference UE(s), determining time and/or frequency resources for SL positioning, detection/determining the presence of SL PRS, setting up and/or configuring SL positioning session, etc.) and perform one or both, based on the determined allowed amount of interruption:
      perform the corresponding operation adaptively to the determined amount of interruption (e.g., reduce, avoid, remove, or compensate the impact of the distorting event; the operation may e.g. be delayed or postponed for the same reason, use or rely on a specific set of resources and/or signals for the same reason, etc.), and/or
      inform implicitly or explicitly another node (e.g., UE or network node) about the determined amount of interruption (the receiving node can use this information, e.g., when performing an SL positioning measurement, processing the SL positioning measurements, determining location, for providing assistance data for SL positioning, for configuring at least one parameter (in the receiving node or another node) related to SL positioning, etc.).
report a measurement together with an indication of whether the distorting event occurred during the measurement period and/or the time and/or frequency resources used for the measurement performed during the SL positioning session with the one or more distorted events.

Receiving the information in Step 702 or informing another node in Step 704 can be, e.g., via L1, L2, and/or L3 signaling; unicast, multicast, or broadcast, directly or via yet another node. Some examples are an RRC message, handover-related message or command, positioning protocol, LPP, LPPe, SL positioning protocol, SUPL, system information, X2, X3, message via SL interface or PC5, etc.

Step 3 (in some examples): the reference UE may further receive a message in response to its action, e.g., confirmation, acknowledgement, a configuration related to handling the distortion, result of an operation triggered by and/or based on its action, etc.

Below are some more specific examples, based on the steps described above:
In one embodiment, a reference UE may signal a target UE that the reference UE is experiencing or likely to experience RLF, RRC reestablishment or handover on its Uu connection.
In one embodiment, the reference UE may signal the LMF or the positioning server UE that the reference UE is experiencing or likely to experience RLF, RRC reestablishment or handover on its Uu connection.
In one embodiment, the reference UE may receive a signaling from the target UE indicating that the target UE is experiencing or likely to experience RLF, RRC reestablishment or handover (on the target UE's Uu connection). Therefore, the reference UE may expect that at least one of:
   The target UE 200 may experience an interruption period so that the target UE may not be able to receive the SL PRS transmission performed by the reference UE 300 during the interruption period.
   The target UE 200 may experience an interruption period so that the target UE 200 may not be able to perform SL PRS transmissions towards the reference UE during the interruption period.
The reference UE 300 may further signal the LMF or the positioning server UE that the target UE 200 is experiencing or likely to experience RLF, RRC reestablishment or handover (on the target UE's Uu connection). Therefore, the reference UE 300 and/or the target UE 200 will not be able to obtain the required positioning measurement results within the required time.
When the target UE 200 is experiencing Uu problem (e.g., RLF, RRC reestablishment or handover), the reference UEs would expect that there may be an interruption due to this. In case the LMF or the positioning server UE is also aware of this issue, i.e., the target UE has Uu problem. The LMF or the positioning server may decide to prolong the positioning session to accommodate the interruption (i.e., this is based on an assumption that the target UE may resume its Uu connection). However, if the target UE cannot resume its Uu connection/recover from the Uu problem, the LMF or the positioning server UE may decide to terminate the current positioning session.
In one embodiment, the reference UE 300 may receive a signaling from the target UE indicating that the target UE 200 will switch to SL positioning resources in another cell. During the rest positioning session, the reference UE 300 needs to monitor SL positioning transmissions from the target UE 200 using those new positioning resources.

A fourth aspect relates to embodiments on a positioning server 400 (e.g., on a LMF 400 or on a positioning server 400 at the UE 200 or 300).

Exemplary step 802: According to this part of the method 800, a positioning server 400 (e.g., in the network node 100 or in a UE 200 or 300) obtains information related to distortion(s) at one or more UE(s) during SL positioning session, wherein the distortion is associated with at least one distorting event of a Uu link at the same or different UE which is involved in the same SL positioning session: RAN connection, cell change (e.g., serving cell change, PCell change, PSCell change, handover, etc.), radio link (re)establishment, RRC (re)establishment, poor radio link quality or radio link failure, etc.
The one or more UEs can comprise at least one of: reference UE and/or target UE.
The distortion(s) can comprise any or more of: interruption in radio signal transmission for SL positioning, interruption in radio signal reception or detection for SL positioning, distortion in SL measurement for SL positioning, distortion in SL measurement reporting, distortion in assistance data provisioning, distortion in any SL positioning related procedure during the SL positioning session, etc. The distortion can be the current distortion or future distortion.
Obtaining the information can further comprise, e.g.:
   receiving the information from another node and/or determining a distortion based on a message from another node (e.g., another UE, another network node, radio network node, a serving cell, a neighbor cell, source cell at handover, target cell at handover, etc.) and/or
   Performing or obtaining a measurement result (e.g., SL radio signal reception/detection/measurement or measurement attempt, mobility measurements, etc.).
The information can comprise, e.g.:
   an indication that the distorting event is taking place, will be taking place, may take place, or likely to take place,
   an indication that the distorting event is over or will be over soon or that the one or more UEs have recovered from the distorting event,
   type of the distorting event,
   implicit or explicit indication of the duration of the distorting event,
   at least one configuration parameter for SL positioning in relation to the distorting event (e.g., SL positioning resource configuration, SL positioning resource pool to be used during handover, SL positioning resource configuration used before the event to enable configuring SL positioning resource configuration in a new cell, SL positioning resource configuration to be used after the event, etc.),
   a measurement result (e.g., a mobility measurement, RRM measurement, SL measurement, SL positioning measurement, DL measurement, UL measurement, etc.).

Exemplary step 804: The positioning server 400, based on the obtained information related to the distortion, may perform one or more of actions in order to handle the distortion during the SL positioning session:
inform at least one other UE in the same SL positioning session about the distortion at the one or more UEs (the information contents can be similar to that described for Step 802, see also embodiments for target UE and reference UE),
inform a radio network node, e.g., gNB (the information contents can be similar to that described for Step 802, see also embodiments for the radio network node),
provide assistance data to one or more UEs in the same SL positioning session,
determine and/or (re)select one or more reference UEs for the SL positioning session,
perform an action impacting or controlling the distorting event (e.g., handover, cell change, connection (re)configuration or (re)establishment, RLF, etc.), e.g., delay, stop, or (re)configuring the distorting event (e.g., to reduce, avoid, or compensate the impact on SL positioning session), etc.
perform, control, adapt, instruct, recommend, or (re)configure at least one of: SL measurements, SL positioning measurement(s), radio signal transmission(s) and/or reception for SL positioning, SL positioning session, etc. which may further comprise e.g. any of:
   configuring a new or an extended duration, extended or additional number of samples or number of transmissions, periodicity, configuring additional transmission/reception occasions to compensate for distortion,
   instructing to perform an action in relation to the distortion (e.g., stop/drop/restart/pause/resume/continue/delay/postpone a measurement, measurement procedure, or individual samples for SL positioning, start/stop/pause/resume transmitting SL PRS, etc.),
   determining a measurement period associated with the distorting event and perform at least one SL positioning measurement based on the determined measurement period (the determined measurement period can be different from that without the distorting event),
   determining an amount of interruption (e.g., an actual or experienced amount of interruption, an allowed amount of interruption, a maximum duration of interruption, number of interrupted time resources, number of dropped or non-available samples due to the distortion, etc.) for at least one operation for SL positioning (e.g., measurement, transmission, measurement processing, selection of reference UE(s), determining time and/or frequency resources for SL positioning, detection/determining the presence of SL PRS, setting up and/or configuring SL positioning session, etc.) and perform one or both, based on the determined allowed amount of interruption:
      perform the corresponding operation adaptively to the determined amount of interruption (e.g., reduce, avoid, remove, or compensate the impact of the distorting event; the operation may e.g. be delayed or postponed for the same reason, use or rely on a specific set of resources and/or signals for the same reason, etc.), and/or
      inform implicitly or explicitly another node (e.g., UE or network node) about the determined amount of interruption (the receiving node can use this information, e.g., when performing an SL positioning measurement, processing the SL positioning measurements, determining location, for providing assistance data for SL positioning, for configuring at least one parameter (in the receiving node or another node) related to SL positioning, etc.).

Receiving the information in Step 802 or informing another node in Step 804 can be, e.g., via L1, L2, and/or L3 signaling; unicast, multicast, or broadcast, directly or via yet another node. Some examples are an RRC message, handover-related message or command, positioning protocol, LPP, LPPe, SL positioning protocol, SUPL, system information, X2, X3, message via SL interface or PC5, etc.

Optional step 806 (in some examples): The positioning server 400 may further receive a message in response to its action, e.g., confirmation, acknowledgement, a configuration related to handling the distortion, result of an operation triggered by and/or based on its action, etc.

Below are some more specific examples, based on the steps described above:
In one embodiment, the LMF or the positioning server UE receives the signaling from a target UE indicating whether a reference UE is experiencing or likely to experience RLF, RRC reestablishment or handover), the LMF or the positioning server UE may further determine whether to reselect another reference UE, or keep the reference UE in the positioning session. For the latter option, it may be due to that the reference UE is expected to recover from the bad radio channel condition soon.
In one embodiment, the LMF or the positioning server UE receives the signaling from a reference UE indicating whether the reference UE is experiencing or likely to experience RLF, RRC reestablishment or handover), the LMF or the positioning server UE may further determine whether to reselect another reference UE, or keep the reference UE in the positioning session. For the latter option, it may be due to that the reference UE is expected to recover from the bad radio channel condition soon.
In one embodiment, the LMF or the positioning server UE receives a signaling from a UE (i.e., a target UE or a reference UE) indicating that the detected event including RLF, RRC reestablishment or handover by the UE has been recovered. In other words, the UE has recovered from the bad radio channel condition.
In one embodiment, the LMF or the positioning server UE may determine not to reselect another reference UE to replace a reference UE which is experiencing RLF, RRC reestablishment or handover. Instead, the LMF or the positioning server UE can instruct the target UE or the rest reference UEs to obtain additional positioning measurements. These additional positioning measurements may compensate the loss of positioning measurements due to removal of the reference UE which is in bad radio channel condition. However, additional positioning measurements may result into additional positioning latency, which may be acceptable given the remaining latency budget of the positioning session/request may be still sufficient long to allow additional positioning measurements.
In addition, the LMF or the positioning server may decide to prolong the positioning session to accommodate the interruption.

Any embodiment of any aspect may use at least one of below signaling details.

In one embodiment, when a UE detects an event on its Uu connection, including RLF, RRC reestablishment or handover is occurring or likely to occur, the UE may select or be instructed by the network (e.g., a gNB) to select a target cell. The UE may further read or receive a signaling from the target cell indicating new SL positioning resources in the target cell. Thereafter, the UE will use the new SL positioning resources to measure or transmit SL PRS. The signaling may be carried by the target cell via one of the below signaling alternatives
System information
RRC signaling (e.g., handover command, RRCReestablishment, RRCRelease or RRCSetup)

As a further embodiment, the signaling carrying SL PRS resources in a target cell may be exchanged between the serving cell and the target cell via inter-gNB interface.

As a further embodiment, the new PRS resources in the target cell may belong to a dedicated SL resource pool for SL positioning, a shared SL resource pool (shared by SL positioning and other SL communication) or an exceptional SL resource pool (which is used by the UE for SL positioning in conditions including detection of RLF, RRC reestablishment or handover.

For any one of the above embodiments, if it is determined to select another anchor UE to replace the anchor UE which has Uu problem. In order to minimize the potential interruption due to change of the anchor UE, the new selected anchor UE may use the same SL positioning resources which were allocated to the old anchor UE, i.e., the SL positioning resources are in the same frequency location/region and the same time location.

For any one of the above embodiments, in order to minimize the negative impact or potential interruption to an on-going SL positioning session due to Uu problem, the UE (i.e., the target UE or the anchor UE) may determine to apply SL positioning resources obtained in scheme 2, since scheme 2 SL positioning resources are available to all UEs regardless of their coverage status. Alternatively, the UE may decide to switch from Scheme 1 to Scheme 2 when the Uu problem is being detected or is likely to occur.

For any one of the above embodiments, any signaling exchanged between two UEs (between a target UE and a reference UE, between a target UE and a server UE or between a reference UE and a server UE) may comprise at least one of the following signaling alternatives.
A SL positioning signaling (e.g., in SL positioning protocol)
A SL discovery procedure
A PC5-S signaling
A PC5-RRC signaling
A MAC CE based signaling
A L1 signaling (e.g., a signaling carried by PSSCH channel, e.g., a SCI, or carried by PSFCH channel)

For the signaling exchange between any UE (reference UE or target UE) and LMF, may be
A new LPP (TS 37.355) or SLPP message
Modification of LPP or SLPP Assistance data exchange message.

For any one of the embodiments, any signaling exchanged between a gNB and the LMF is carried via one of the below signaling alternatives
A NRPPa message (TS 38.455)
A Ngap Signaling

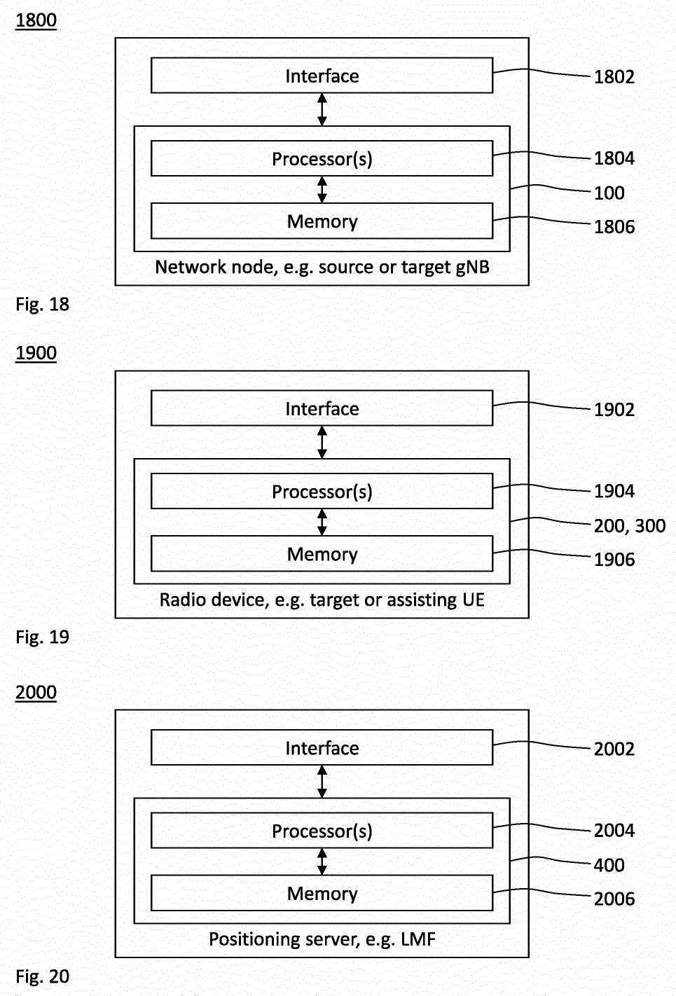

FIG. 18 shows a schematic block diagram for an embodiment of the device 100. The device 100 comprises processing circuitry, e.g., one or more processors 1804 for performing the method 500 and memory 1806 coupled to the processors 1804. For example, the memory 1806 may be encoded with instructions that implement at least one of the modules 102 and 104.

The one or more processors 1804 may be a combination of one or more of a microprocessor, controller, microcontroller, central processing unit, digital signal processor, application specific integrated circuit, field programmable gate array, or any other suitable computing device, resource, or combination of hardware, microcode and/or encoded logic operable to provide, either alone or in conjunction with other components of the device 100, such as the memory 1806, network node functionality. For example, the one or more processors 1804 may execute instructions stored in the memory 1806. Such functionality may include providing various features and steps discussed herein, including any of the benefits disclosed herein. The expression “the device being operative to perform an action” may denote the device 100 being configured to perform the action.

As schematically illustrated in FIG. 18, the device 100 may be embodied by a network node 1800, e.g., functioning as a base station or a gateway UE. The transmitting station 1800 comprises a radio interface 1802 coupled to the device 100 for radio communication with one or more receiving stations, e.g., functioning as a receiving base station or a receiving UE.

FIG. 19 shows a schematic block diagram for an embodiment of the device 200 or 300. The device 200 or 300 comprises processing circuitry, e.g., one or more processors 1904 for performing the method 600 or 700 and memory 1906 coupled to the processors 1904. For example, the memory 1906 may be encoded with instructions that implement at least one of the modules 202 and 204 or 302 and 304.

The one or more processors 1904 may be a combination of one or more of a microprocessor, controller, microcontroller, central processing unit, digital signal processor, application specific integrated circuit, field programmable gate array, or any other suitable computing device, resource, or combination of hardware, microcode and/or encoded logic operable to provide, either alone or in conjunction with other components of the device 200 or 300, such as the memory 1906, radio device functionality. For example, the one or more processors 1904 may execute instructions stored in the memory 1906. Such functionality may include providing various features and steps discussed herein, including any of the benefits disclosed herein. The expression “the device being operative to perform an action” may denote the device 200 or 300 being configured to perform the action.

As schematically illustrated in FIG. 19, the device 200 or 300 may be embodied by a radio device 1900, e.g., functioning as a target radio device and/or an assisting radio device (UE). The radio device 1900 comprises a radio interface 1902 coupled to the device 200 for radio communication with one or more network node, e.g., functioning as the device 100 or 400.

FIG. 20 shows a schematic block diagram for an embodiment of the device 400. The device 400 comprises processing circuitry, e.g., one or more processors 2004 for performing the method 800 and memory 2006 coupled to the processors 2004. For example, the memory 2006 may be encoded with instructions that implement at least one of the modules 402 and 404.

The one or more processors 2004 may be a combination of one or more of a microprocessor, controller, microcontroller, central processing unit, digital signal processor, application specific integrated circuit, field programmable gate array, or any other suitable computing device, resource, or combination of hardware, microcode and/or encoded logic operable to provide, either alone or in conjunction with other components of the device 400, such as the memory 2006, positioning server functionality. For example, the one or more processors 2004 may execute instructions stored in the memory 2006. Such functionality may include providing various features and steps discussed herein, including any of the benefits disclosed herein. The expression “the device being operative to perform an action” may denote the device 200 being configured to perform the action.

As schematically illustrated in FIG. 20, the device 200 may be embodied by a positioning server 2000, e.g., functioning as a positioning server UE or an LMF in a core network. The receiving station 2000 comprises an interface 2002 coupled to the device 400 for (e.g., backhaul or NAS) communication with one or more radio devices and network nodes, e.g., functioning as the device 100, 200 or 300.

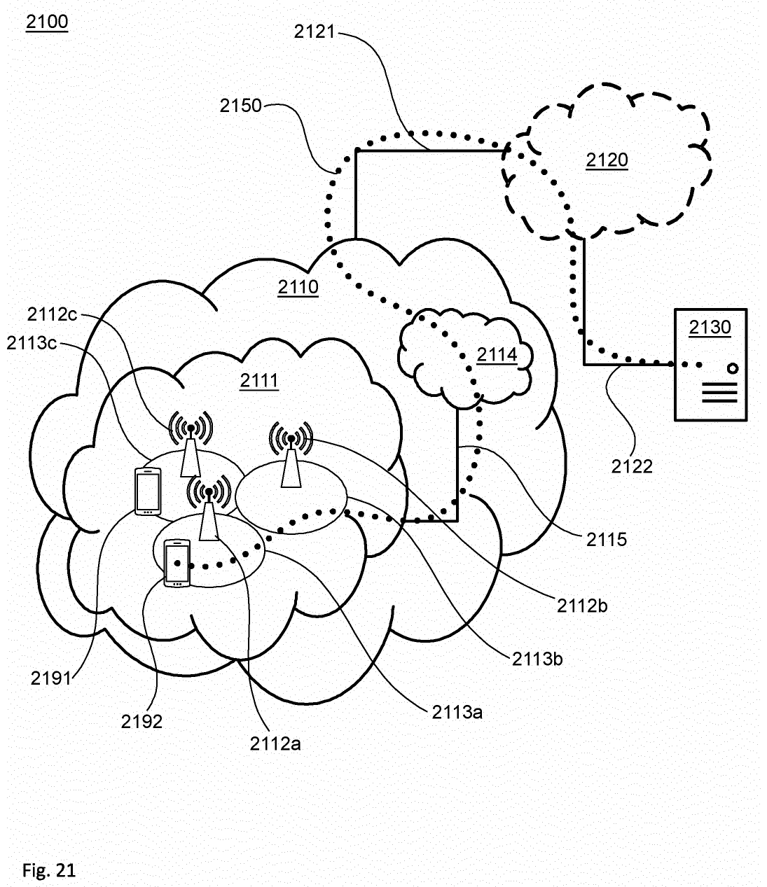

With reference to FIG. 21, in accordance with an embodiment, a communication system 2100 includes a telecommunication network 2110, such as a 3GPP-type cellular network, which comprises an access network 2111, such as a radio access network, and a core network 2114. The access network 2111 comprises a plurality of base stations 2112a, 2112b, 2112c, such as NBs, eNBs, gNBs or other types of wireless access points, each defining a corresponding coverage area 2113a, 2113b, 2113c. Each base station 2112a, 2112b, 2112c is connectable to the core network 2114 over a wired or wireless connection 2115. A first user equipment (UE) 2191 located in coverage area 2113c is configured to wirelessly connect to, or be paged by, the corresponding base station 2112c. A second UE 2192 in coverage area 2113a is wirelessly connectable to the corresponding base station 2112a. While a plurality of UEs 2191, 2192 are illustrated in this example, the disclosed embodiments are equally applicable to a situation where a sole UE is in the coverage area or where a sole UE is connecting to the corresponding base station 2112.

Any of the base stations 2112 may embody the device 100. Alternatively or in addition, any of the UEs 2191 and 2192 may embody the device 200 and/or 300.

The telecommunication network 2110 is itself connected to a host computer 2130, which may be embodied in the hardware and/or software of a standalone server, a cloud-implemented server, a distributed server or as processing resources in a server farm. The host computer 2130 may be under the ownership or control of a service provider, or may be operated by the service provider or on behalf of the service provider. The connections 2121, 2122 between the telecommunication network 2110 and the host computer 2130 may extend directly from the core network 2114 to the host computer 2130 or may go via an optional intermediate network 2120. The intermediate network 2120 may be one of, or a combination of more than one of, a public, private or hosted network; the intermediate network 2120, if any, may be a backbone network or the Internet; in particular, the intermediate network 2120 may comprise two or more sub-networks (not shown).

The communication system 2100 of FIG. 21 as a whole enables connectivity between one of the connected UEs 2191, 2192 and the host computer 2130. The connectivity may be described as an over-the-top (OTT) connection 2150. The host computer 2130 and the connected UEs 2191, 2192 are configured to communicate data and/or signaling via the OTT connection 2150, using the access network 2111, the core network 2114, any intermediate network 2120 and possible further infrastructure (not shown) as intermediaries. The OTT connection 2150 may be transparent in the sense that the participating communication devices through which the OTT connection 2150 passes are unaware of routing of uplink and downlink communications. For example, a base station 2112 need not be informed about the past routing of an incoming downlink communication with data originating from a host computer 2130 to be forwarded (e.g., handed over) to a connected UE 2191. Similarly, the base station 2112 need not be aware of the future routing of an outgoing uplink communication originating from the UE 2191 towards the host computer 2130.

By virtue of the method 500 being performed by any one of the base stations 2112, the method 600 and/or 700 being performed by any one of the UEs 2191 or 2192, and/or the method 800 being performed by any of the host computer 2130, the base stations 2112 or the UEs 2191 and 2192, the performance or range of the OTT connection 2150 can be improved, e.g., in terms of increased (e.g., indoors) positioning functionality. More specifically, the host computer 2130 may indicate to the RAN 910 or the target radio device 200 or the assisting radio devices 300 (e.g., on an application layer) the QoS of the traffic or the positioning.

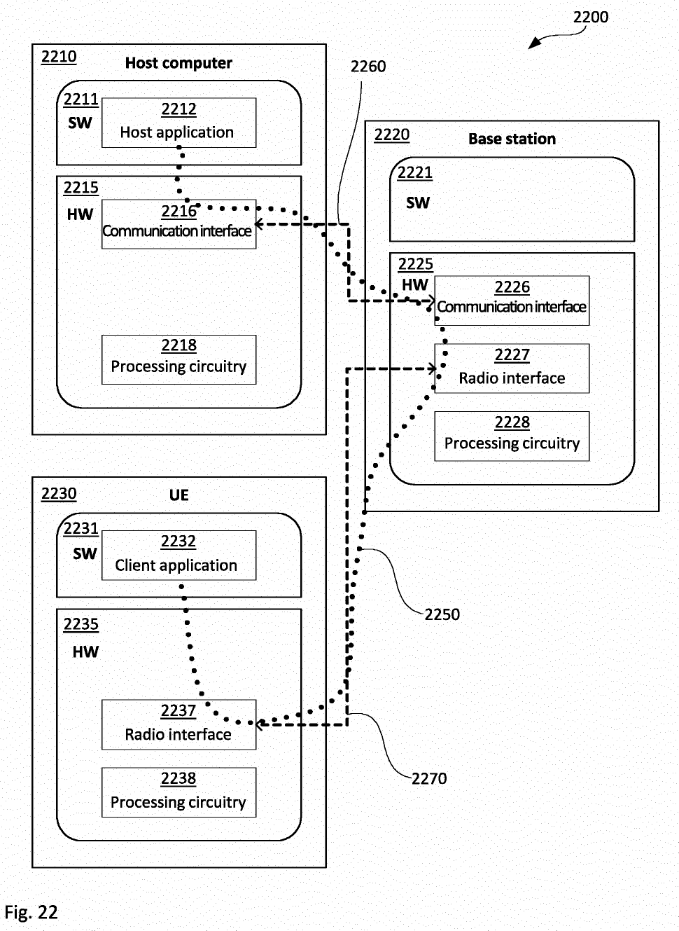

Example implementations, in accordance with an embodiment of the UE, base station and host computer discussed in the preceding paragraphs, will now be described with reference to FIG. 22. In a communication system 2200, a host computer 2210 comprises hardware 2215 including a communication interface 2216 configured to set up and maintain a wired or wireless connection with an interface of a different communication device of the communication system 2200. The host computer 2210 further comprises processing circuitry 2218, which may have storage and/or processing capabilities. In particular, the processing circuitry 2218 may comprise one or more programmable processors, application-specific integrated circuits, field programmable gate arrays or combinations of these (not shown) adapted to execute instructions. The host computer 2210 further comprises software 2211, which is stored in or accessible by the host computer 2210 and executable by the processing circuitry 2218. The software 2211 includes a host application 2212. The host application 2212 may be operable to provide a service to a remote user, such as a UE 2230 connecting via an OTT connection 2250 terminating at the UE 2230 and the host computer 2210. In providing the service to the remote user, the host application 2212 may provide user data, which is transmitted using the OTT connection 2250. The user data may depend on the position (e.g., location) of the UE 2230 as determined by means of the SL positioning procedure of any one of the methods 500, 600, 700, and 800. The user data may comprise auxiliary information or precision advertisements (also: ads) delivered to the UE 2230. The location may be reported by the UE 2230 to the host computer, e.g., using the OTT connection 2250, and/or by the base station 2220, e.g., using a connection 2260 (e.g., as a result of the SL positioning procedure or as measurement reports of the SL positioning procedure that are processed at the host computer 2210 in the method 800).

The communication system 2200 further includes a network node (e.g., a base station) 2220 provided in a telecommunication system and comprising hardware 2225 enabling it to communicate with the host computer 2210 and with the UE 2230. The hardware 2225 may include a communication interface 2226 for setting up and maintaining a wired or wireless connection with an interface of a different communication device of the communication system 2200, as well as a radio interface 2227 for setting up and maintaining at least a wireless connection 2270 with a UE 2230 located in a coverage area (not shown in FIG. 22) served by the base station 2220. The communication interface 2226 may be configured to facilitate a connection 2260 to the host computer 2210. The connection 2260 may be direct, or it may pass through a core network (not shown in FIG. 22) of the telecommunication system and/or through one or more intermediate networks outside the telecommunication system. In the embodiment shown, the hardware 2225 of the base station 2220 further includes processing circuitry 2228, which may comprise one or more programmable processors, application-specific integrated circuits, field programmable gate arrays or combinations of these (not shown) adapted to execute instructions. The base station 2220 further has software 2221 stored internally or accessible via an external connection.

The communication system 2200 further includes the UE 2230 already referred to. Its hardware 2235 may include a radio interface 2237 configured to set up and maintain a wireless connection 2270 with a base station serving a coverage area in which the UE 2230 is currently located. The hardware 2235 of the UE 2230 further includes processing circuitry 2238, which may comprise one or more programmable processors, application-specific integrated circuits, field programmable gate arrays or combinations of these (not shown) adapted to execute instructions. The UE 2230 further comprises software 2231, which is stored in or accessible by the UE 2230 and executable by the processing circuitry 2238. The software 2231 includes a client application 2232. The client application 2232 may be operable to provide a service to a human or non-human user via the UE 2230, with the support of the host computer 2210. In the host computer 2210, an executing host application 2212 may communicate with the executing client application 2232 via the OTT connection 2250 terminating at the UE 2230 and the host computer 2210. In providing the service to the user, the client application 2232 may receive request data from the host application 2212 and provide user data in response to the request data. The OTT connection 2250 may transfer both the request data and the user data. The client application 2232 may interact with the user to generate the user data that it provides.

It is noted that the host computer 2210, base station 2220 and UE 2230 illustrated in FIG. 22 may be identical to the host computer 2130, one of the base stations 2112a, 2112b, 2112c and one of the UEs 2191, 2192 of FIG. 21, respectively. This is to say, the inner workings of these entities may be as shown in FIG. 22, and, independently, the surrounding network topology may be that of FIG. 21.

In FIG. 22, the OTT connection 2250 has been drawn abstractly to illustrate the communication between the host computer 2210 and the UE 2230 via the base station 2220, without explicit reference to any intermediary devices and the precise routing of messages via these devices. Network infrastructure may determine the routing, which it may be configured to hide from the UE 2230 or from the service provider operating the host computer 2210, or both. While the OTT connection 2250 is active, the network infrastructure may further take decisions by which it dynamically changes the routing (e.g., on the basis of load balancing consideration or reconfiguration of the network).

The wireless connection 2270 between the UE 2230 and the base station 2220 is in accordance with the teachings of the embodiments described throughout this disclosure. One or more of the various embodiments improve the performance of OTT services provided to the UE 2230 using the OTT connection 2250, in which the wireless connection 2270 forms the last segment. More precisely, the teachings of these embodiments may reduce the latency and improve the data rate and thereby provide benefits such as better responsiveness and improved QoS.

A measurement procedure may be provided for the purpose of monitoring data rate, latency, QoS and other factors on which the one or more embodiments improve. There may further be an optional network functionality for reconfiguring the OTT connection 2250 between the host computer 2210 and UE 2230, in response to variations in the measurement results. The measurement procedure and/or the network functionality for reconfiguring the OTT connection 2250 may be implemented in the software 2211 of the host computer 2210 or in the software 2231 of the UE 2230, or both. In embodiments, sensors (not shown) may be deployed in or in association with communication devices through which the OTT connection 2250 passes; the sensors may participate in the measurement procedure by supplying values of the monitored quantities exemplified above, or supplying values of other physical quantities from which software 2211, 2231 may compute or estimate the monitored quantities. The reconfiguring of the OTT connection 2250 may include message format, retransmission settings, preferred routing etc.; the reconfiguring need not affect the base station 2220, and it may be unknown or imperceptible to the base station 2220. Such procedures and functionalities may be known and practiced in the art. In certain embodiments, measurements may involve proprietary UE signaling facilitating the host computer's 2210 measurements of throughput, propagation times, latency and the like. The measurements may be implemented in that the software 2211, 2231 causes messages to be transmitted, in particular empty or “dummy” messages, using the OTT connection 2250 while it monitors propagation times, errors etc.

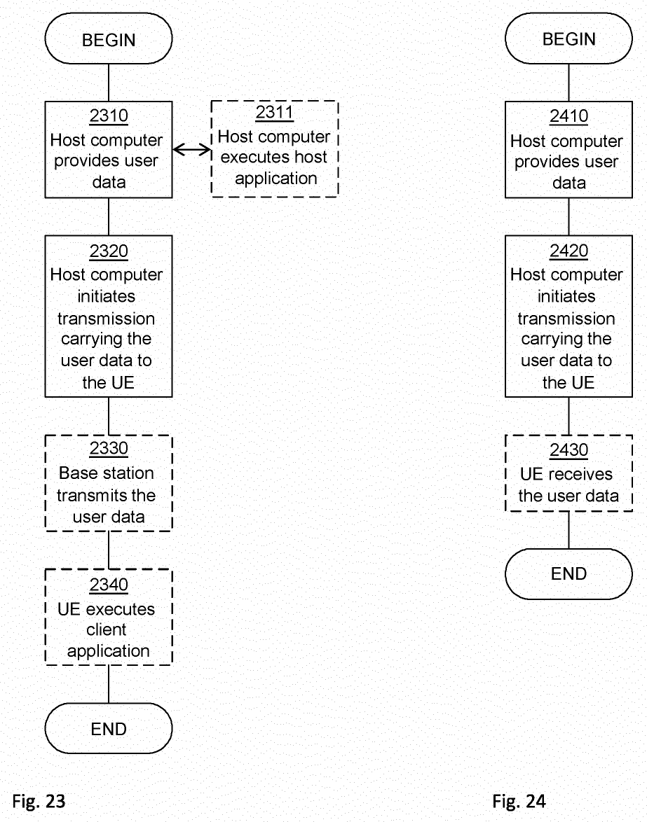

FIG. 23 is a flowchart illustrating a method implemented in a communication system, in accordance with one embodiment. The communication system includes a host computer, a base station and a UE which may be those described with reference to FIGS. 21 and 22. For simplicity of the present disclosure, only drawing references to FIG. 23 will be included in this paragraph. In a first step 2310 of the method, the host computer provides user data. In an optional substep 2311 of the first step 2310, the host computer provides the user data by executing a host application. In a second step 2320, the host computer initiates a transmission carrying the user data to the UE. In an optional third step 2330, the base station transmits to the UE the user data which was carried in the transmission that the host computer initiated, in accordance with the teachings of the embodiments described throughout this disclosure. In an optional fourth step 2340, the UE executes a client application associated with the host application executed by the host computer.

FIG. 24 is a flowchart illustrating a method implemented in a communication system, in accordance with one embodiment. The communication system includes a host computer, a base station and a UE which may be those described with reference to FIGS. 21 and 22. For simplicity of the present disclosure, only drawing references to FIG. 24 will be included in this paragraph. In a first step 2410 of the method, the host computer provides user data. In an optional substep (not shown) the host computer provides the user data by executing a host application. In a second step 2420, the host computer initiates a transmission carrying the user data to the UE. The transmission may pass via the base station, in accordance with the teachings of the embodiments described throughout this disclosure. In an optional third step 2430, the UE receives the user data carried in the transmission.

As has become apparent from above description, at least some embodiments of the technique can be used to control the impact of events associated with a RAN connection, which event may distort an ongoing SL positioning procedure (e.g., within one SL positioning session). Such events may encompass, e.g., cell change, handover, RRC (re-)configuration, connection (re-)establishment.

Many advantages of the present invention will be fully understood from the foregoing description, and it will be apparent that various changes may be made in the form, construction and arrangement of the units and devices without departing from the scope of the invention and/or without sacrificing all of its advantages. Since the invention can be varied in many ways, it will be recognized that the invention should be limited only by the scope of the following claims.

Alternatively or in addition, the disclosure comprises the following embodiments, which may be implemented alone or in combination with above description.
1. A method (500; 600; 700; 800) of handling a sidelink, SL, positioning procedure, the method (500; 600; 700; 800) comprising or initiating:
obtaining (502; 602; 702; 802) information indicative of a distortion of a radio link of at least one radio device (200; 300) among radio devices (200, 300) involved in the SL positioning procedure; and
   performing (504; 604; 704; 804) one or more actions that handle the distortion based on the obtained (502; 602; 702; 802) information.

The method may be implemented as a method of handling the distortion and/or as a method of performing the SL positioning procedure.

The SL positioning procedure may comprise a SL positioning session (e.g., a step of discovering the radio devices involved in the SL positioning procedure and/or a step of establishing and/or releasing the SL positioning session). The SL positioning session may involve the at least one radio device.

The one or more actions may be performed during the SL positioning procedure (e.g., during the SL positioning session).

The radio devices involved in the SL positioning procedure may comprise only radio devices involved in the same SL positioning procedure (e.g., participants of the same positioning session). Alternatively or in addition, the radio devices involved in the SL positioning procedure may comprise only radio devices served by the same network node of a radio access network (RAN).

The SL positioning procedure may determine the position of a target radio device. The at least one radio device may be, or may comprise, the target radio device. Alternatively or in addition, the at least one radio device may be, or may comprise, one or more assisting radio devices that assist in the SL positioning procedure.

The information may be indicative that the at least one radio device (e.g., the target radio device) is experiencing the distortion (e.g., a radio problem), optionally associated with a radio link failure (RLF), an RRC reestablishment, or a handover.
2. The method (500; 600; 700; 800) of embodiment 1, wherein the radio devices (200, 300) involved in the SL positioning procedure comprise a target radio (200) which position is determined by the SL positioning procedure and/or one or more assisting radio devices (300) which assist the target radio device (200) in the SL positioning procedure.

The one or more assisting radio devices may comprise one or more reference radio devices (also referred to as anchor radio devices).

The target radio device and the one or more assisting radio devices may exchange reference signals (RSs) according to the SL positioning procedure. For example, the radio devices can measure a time difference of arrival (TDoA) or an angle of arrival (AoA) of reference signals received from each other or from other radio devices and use this information to estimate at least the position of the target radio device. Alternatively or in addition, the radio devices can exchange positioning information about their position with other radio devices, which improves the accuracy of the positioning. The positioning accuracy can be improved by using multiple devices for the measurements and by signal processing to estimate the position.
3. The method (500; 600; 700; 800) of embodiment 1 or 2, wherein the indicated radio link is used for allocating SL positioning resources to the at least one radio device (200; 300) prior to the distortion.

Allocating the SL positioning resources may encompass at least one of: (e.g., dynamically) scheduling the SL positioning resources (e.g., according to mode 1), configuring a grant (e.g., according to type 1) for the SL positioning resources, and activating or deactivating a configured grant (e.g., according to type 2) for the SL positioning resources.
4. The method (500; 600; 700; 800) of any one of embodiments 1 to 3, wherein the at least one radio device (200; 300) is transmitting or receiving SL reference signals for the SL positioning procedure.

The involvement of the at least one radio device in the SL positioning procedure may comprise transmitting or receiving reference signals for the SL positioning procedure. Alternatively or in addition, the reference signal for the SL positioning procedure may comprise SL positioning reference signals (SL PRS) and/or SL sounding reference signals (SL SRS).

Alternatively or in addition, the at least one radio device being involved in the SL positioning procedure may mean that the at least one radio device has ongoing allocated SL positioning resources in the SL positioning procedure.
5. The method (500; 600; 700; 800) of embodiments 3 and 4, wherein the at least one radio device (200; 300) is transmitting and/or receiving the SL reference signals for the SL positioning procedure using the allocated SL positioning resources.

The indicated radio link may be a radio link between a radio access network (RAN) and the at least one radio device. The RAN may comprise at least one network node involved in the SL positioning procedure.
6. The method (500; 600; 700; 800) of any one of embodiments 1 to 5, wherein the indicated radio link is a radio link, optionally a downlink or an uplink, between the at least one radio device (200; 300) and a network node (100) serving the at least one radio device (200) and/or a Uu interface at the at least one radio device (200; 300).

The indicated radio link that is subject to the distortion may be at the same at least one radio device that is involved in the SL positioning procedure. Alternatively or in addition, the indicated radio link that is subject to the distortion may be different from a SL interface (e.g., a PC5 interface) used by the at least one radio device for the SL positioning procedure.

The indicated radio link may be a downlink (DL), e.g. a physical DL control channel (PDCCH) carrying downlink control information (DCI) or a physical DL shared channel (PDSCH) carrying a MAC CE or RRC signaling for the allocation of the SL positioning resources.

The distortion (e.g., a link failure) may occur on the uplink, e.g. due to a radio link control (RLC) retransmission time out and/or reaching a maximum number of RLC UL retransmissions and/or reaching a maximum number of random access channel (RACH) preamble (also: random access preamble, RAP) transmission attempts.
7. The method (500; 600; 700; 800) of any one of embodiments 1 to 6, wherein the method (500; 600; 700; 800) is performed by at least one of:
   the network node (100) serving the at least one radio device (200; 300);
   the target radio device (200);
   the one or more assisting radio devices (300); and
   the positioning server (400), optionally a location management function, LMF (400).
8. The method (500; 600; 700; 800) of any one of embodiments 1 to 7, wherein the distortion is associated with a radio protocol event at the at least one radio device (200; 300).
9. The method (500; 600; 700; 800) of embodiment 8, wherein the radio protocol event includes at least one of:
a handover, HO, of the at least one radio device (200; 300);
a cell change of the at least one radio device (200; 300);
a radio resource control, RRC, connection establishment or an RRC connection re-establishment of the indicated radio link;
an RRC configuration or an RRC reconfiguration of the indicated radio link;
the at least one radio device (200; 300) triggering a HO in the RRC connected mode;
a link quality of the indicated radio link being less than a predefined link quality threshold;
a RAN connection failure;
a radio link failure, RLF, of the indicated radio link; and
a beam failure detection or beam failure recovery of the indicated radio link.

The link quality and the link quality threshold may be defined in terms of at least one of: a reference signal received power (RSRP), a reference signal received quality (RSRQ), and a received signal strength indicator (RSSI). Herein, “predefined” may encompass at least one of specified in a technical standard, configured (e.g., by the RAN such as the serving network node), and encoded (e.g., hard-coded) at the radio device.
10. The method (500; 600; 700; 800) of any one of embodiments 1 to 9, wherein obtaining (502; 602; 702; 802) the information comprises receiving a control message indicative of the distortion of the radio link of the at least one radio device (200; 300).
11. the Method (500; 600; 700; 800) of any one of embodiments 1 to 10, further comprising or initiating:
receiving (506; 606; 706; 806) a message in response to the performed (504; 604; 704;
804 one or more actions, optionally wherein the message is received (506; 606; 706;
806) from the at least one radio device (200; 300) or a network node (100) serving the at least one radio device (200; 300); and/or
transmitting (506; 606; 706; 806) a message in response to the performed (504; 604; 704;
804) one or more actions, optionally wherein the message is transmitted (506; 606; 706) from the at least one radio device (200; 300) or a network node (100) serving the at least one radio device (200; 300).

The received message may comprise a handover (HO) command. The HO command may be indicative of (e.g., a configuration of) SL positioning resource in a target cell of the HO and/or allocated by the target network node.
12. The method (500; 600; 700; 800) of any one of embodiments 1 to 11, wherein the distortion is associated with a context fetch procedure or a RRC resume procedure for the at least one radio device (200; 300) in the RRC inactive state and/or the information is obtained (502) over an Xn interface and/or the obtaining (502) includes receiving an RRC resume request indicative of at least one of the ongoing SL positioning procedure and the allocation of SL positioning resources.
13. The method (500; 600; 700; 800) of any one of embodiments 1 to 12, wherein the action includes the at least one radio device (200; 300) transmitting an RRC resume request in the RRC inactive state, optionally wherein the RRC resume request is indicative of at least one of the ongoing SL positioning procedure and the allocation of SL positioning resources.
14. The method (500; 600; 700; 800) of any one of embodiments 1 to 13, wherein the distortion is associated with a handover procedure for the at least one radio device (200; 300) in the RRC connected state and/or the information is obtained (502) over an Xn interface.
15. The method (500; 600; 700; 800) of any one of embodiments 1 to 14, wherein the action includes the at least one radio device (200; 300) transmitting a measurement report and/or an RRC establishment setup complete message, optionally wherein the measurement report or the RRC establishment setup complete message is indicative of at least one of the ongoing SL positioning procedure and the allocation of SL positioning resources.

The measurement report may be indicative of an event, e.g. the radio protocol event, for a handover (HO) or a conditional handover (CHO).
16. The method (500; 600; 700; 800) of any one of embodiments 1 to 15, wherein the obtaining (502) of the information comprises determining if SL positioning resources are allocated to the at least one radio device (200; 300) and/or the performing (502) of the action includes a source network node (100) of a or the handover procedure providing (504) a dimension of the allocated SL positioning resource, optionally via an Xn interface, and/or the performing (502) of the action includes a target network node (100′) of a or the handover procedure receiving (504) a dimension of the allocated SL positioning resource, optionally via an Xn interface, and/or the action includes a target network node (100′) of a or the handover procedure allocating (504) new SL positioning resource to the at least one radio device (200; 300).

The positioning server may be embodied by a location management function, LMF, of the core network (CN). Alternatively or in addition, the positioning server may be implemented by a radio device of the radio devices involved in the SL positioning procedure, e.g., by the target radio device. The target network node is referred to using a reference sign 100′ as an example of the device generally referred to by the reference sign 100.
17. The method (500; 600; 700; 800) of any one of embodiments 1 to 16, wherein the performing (604; 704) of the action comprises sending (604; 704) the information from the at least one radio device (200; 300), optionally from the target radio device (200) or the one or more assisting radio devices (300); and/or
wherein the performing (604; 704) of the action comprises sending (604; 704) the information to a positioning server (400); and/or
wherein the performing (604; 704) of the action comprises sending (604; 704) the information in a non-access stratum (NAS) message.
18. The method (500; 600; 700; 800) of any one of embodiments 1 to 17, wherein the information is obtained (802) from the at least one radio device (200; 300), optionally from the target radio device (200) or the one or more assisting radio devices (300); and/or
wherein the information is obtained (802) at a positioning server (400); and/or
wherein the information is obtained (802) in a non-access stratum (NAS) message.

The positioning server may be embodied by a location management function, LMF, of the core network (CN). Alternatively or in addition, the positioning server may be implemented by a radio device of the radio devices involved in the SL positioning procedure, e.g., by the target radio device.
19. The method (500; 600; 700; 800) of any one of embodiments 1 to 18, wherein the performing (504; 604; 804) of the action comprises determining whether the at least one radio device (200; 300), optionally the one or more assisting radio devices (300), is kept or replaced in the SL positioning procedure.
20. The method (500; 600; 700; 800) of any one of embodiments 1 to 19, wherein the performing (504; 604; 804) of the action comprises allocating SL positioning resources to the one or more replacing assisting radio devices (300), and/or
wherein the one or more replacing assisting radio devices (300) are allocated the SL positioning resources previously allocated to the one or more replaced assisting radio devices (300).
21. The method (500; 600; 700; 800) of any one of embodiments 1 to 20, wherein the performing (604) of the action comprises the target radio device (200) transmitting, on a SL to the one or more replacing assisting radio devices (300), an allocation message indicative of the SL positioning resources allocated to the one or more replacing assisting radio devices (300), optionally using PC5 RRC signaling or a medium access control element, MAC CE.
22. The method (500; 600; 700; 800) of any one of embodiments 1 to 21, wherein the performing (504) of the action comprises the network node (100) serving the replaced assisting radio device (300) to transmit an allocation message indicative of the SL positioning resources allocated to the replacing assisting radio devices (300), optionally using Uu RRC signaling or a MAC CE.
23. The method (500; 600; 700; 800) of any one of embodiments 1 to 22, wherein the performing (804) of the action comprises the positioning server (400), optionally the LMF (400), to transmit an allocation message indicative of the SL positioning resources allocated to the replacing assisting radio devices (300), optionally using NR Positioning Protocol A, NPPa, or LTE positioning protocol, LPP, signaling.
24. The method (500; 600; 700; 800) of any one of embodiments 1 to 23, wherein the performing (504) of the action comprises the target network node (100′) transmitting (504), to the at least one radio device (200; 300), a handover command, HO command, based on the obtained (804) information, optionally the HO command being indicative of a configuration of SL positioning resources allocated to the at least one radio device (200; 300)
25. The method (500; 600; 700; 800) of any one of embodiments 1 to 24, wherein the allocated SL positioning resources include one or multiple TX resource pools on a SL carrier and/or one or multiple RX resource pools on a SL carrier, optionally in the target cell of the HO.
26. The method (500; 600; 700; 800) of any one of embodiments 1 to 25, wherein the obtained (502; 602; 702; 802) information is indicative of a scope of an interruption caused by the distortion; and/or
wherein the performing (504; 604; 704; 804) of the action comprises determining, based on the obtained (502; 602; 702; 802) information, a scope of an interruption caused by the distortion; and/or
wherein the performing (504; 604; 704; 804) of the action comprises processing SL positioning measurements based on the scope of the interruption caused by the distortion, determining the position of the target radio device (200) taking into account the scope of the interruption caused by the distortion, providing assistance data for the SL positioning procedure taking into account the scope of the interruption caused by the distortion, and configuring at least one parameter of the SL positioning procedure based on the scope of the interruption caused by the distortion.

For example, the processing of SL positioning measurements may exclude measurements (e.g., assistance data) affected by the interruption.
27. The method (500; 600; 700; 800) of any one of embodiments 1 to 26, wherein the action performed (504; 604; 704; 804) based on the obtained (502; 602; 702; 802) information related to the distortion impacts or controls a distorting event causing the distortion, optionally the radio protocol event; and/or
wherein the action comprises delaying, stopping, reconfiguring the distorting event to reduce, avoid, or compensate an impact on the SL positioning procedure.

Any one of the features and steps disclosed herein can be implemented at any one of the four aspects including the network node, the target radio device, the one or more assisting radio devices, and the positioning server (e.g., a location management function, LMF).
28. A computer program product comprising program code portions for performing the steps of any one of the embodiments 1 to 27 when the computer program product is executed on one or more computing devices (1804; 1904; 2004), optionally stored on a computer-readable recording medium (1806; 1906; 2006).
29. A network node (100; 1800; 2112; 2220) comprising memory (1806) operable to store instructions and processing circuitry (1804) operable to execute the instructions, such that the network node (100; 1800; 2112; 2220) is operable to: obtain information indicative of a distortion of a radio link of at least one radio device (200; 300) among radio devices (200, 300) involved in a SL positioning procedure; and
   perform one or more actions that handle the distortion based on the obtained information.
30. The network node (100; 1800; 2112; 2220) of embodiment 29, further operable to perform any one of the steps of any one of embodiments 2 to 27.
31. A network node (100; 1800; 2112; 2220) configured to:
obtain information indicative of a distortion of a radio link of at least one radio device (200; 300) among radio devices (200, 300) involved in a SL positioning procedure; and
   perform one or more actions that handle the distortion based on the obtained information.
32. The network node (100; 1800; 2112; 2220) of embodiment 31, further configured to perform the steps of any one of embodiment 2 to 27.
33. A target radio device (200; 1900; 2191; 2192; 2230) comprising memory (1906) operable to store instructions and processing circuitry (1904) operable to execute the instructions, such that the radio device (200; 1900; 2191; 2192; 2230) is operable to: obtain information indicative of a distortion of a radio link of at least one radio device (200; 300) among radio devices (200, 300) involved in a SL positioning procedure; and
   perform one or more actions that handle the distortion based on the obtained information.
34. The target radio device (200; 300; 1900; 2191; 2192; 2230) of embodiment 33, further operable to perform the steps of any one of embodiments 2 to 27.
35. A target radio device (200; 1900; 2191; 2192; 2230) configured to:
obtain information indicative of a distortion of a radio link of at least one radio device (200; 300) among radio devices (200, 300) involved in a SL positioning procedure; and
   perform one or more actions that handle the distortion based on the obtained information.
36. The target radio device (200; 1900; 2191; 2192; 2230) of embodiment 35, further configured to perform the steps of any one of embodiments 2 to 27.
37. An assisting radio device (300; 1900; 2191; 2192; 2230) comprising memory (1906) operable to store instructions and processing circuitry (1904) operable to execute the instructions, such that the radio device (300; 1900; 2191; 2192; 2230) is operable to:
obtain information indicative of a distortion of a radio link of at least one radio device (200; 300) among radio devices (200, 300) involved in a SL positioning procedure; and
   perform one or more actions that handle the distortion based on the obtained information.
38. The assisting radio device (300; 1900; 2191; 2192; 2230) of embodiment 37, further operable to perform the steps of any one of embodiments 2 to 27.
39. An assisting radio device (300; 1900; 2191; 2192; 2230) configured to:
obtain information indicative of a distortion of a radio link of at least one radio device (200; 300) among radio devices (200, 300) involved in a SL positioning procedure; and
   perform one or more actions that handle the distortion based on the obtained information.
40. The assisting radio device (300; 1900; 2191; 2192; 2230) of embodiment 39, further configured to perform the steps of any one of embodiments 2 to 27.
41. A positioning server (400; 2000; 2130; 2210) comprising memory (2006) operable to store instructions and processing circuitry (2004) operable to execute the instructions, such that the positioning server (400; 2000; 2130; 2210) is operable to:
obtain information indicative of a distortion of a radio link of at least one radio device (200; 300) among radio devices (200, 300) involved in a SL positioning procedure; and
   perform one or more actions that handle the distortion based on the obtained information.
42. The positioning server (400; 2000; 2130; 2210) of embodiment 41, further operable to perform the steps of any one of embodiments 2 to 27.
43. A positioning server (400; 2000; 2130; 2210) configured to:
obtain information indicative of a distortion of a radio link of at least one radio device (200; 300) among radio devices (200, 300) involved in a SL positioning procedure; and
   perform one or more actions that handle the distortion based on the obtained information.
44. The positioning server (400; 2000; 2130; 2210) of embodiment 43, further configured to perform the steps of any one of embodiments 2 to 27.
45. A communication system (2100; 2200) including a host computer (1330; 1410) comprising:
   processing circuitry (2218) configured to provide user data; and
   a communication interface (2216) configured to forward user data to a cellular or ad hoc radio network (1310) for transmission to a user equipment, UE, (200; 300; 1900; 2191; 2192; 2230) wherein the UE (200; 300; 1900; 2191; 2192; 2230) comprises a radio interface (1902; 2237) and processing circuitry (1904; 2238), the processing circuitry (1904; 2238) of the UE (200; 300; 1900; 2191; 2192; 2230) being configured to execute the steps of any one of embodiments 1 to 27.
46. The communication system (2100; 2200) of embodiment 45, further including the UE (200; 300; 1900; 2191; 2192; 2230).
47. The communication system (2100; 2200) of embodiment 45 or 46, wherein the radio network (1310) further comprises a base station (100; 1800; 2112; 2220), or a radio device (200; 300; 1900; 2191; 2192; 2230) functioning as a gateway, which is configured to communicate with the UE (200; 300; 1900; 2191; 2192; 2230).
48. The communication system (2100; 2200) of embodiment 47, wherein the base station (100; 1800; 2112; 2220), or the radio device (200; 300; 1900; 2191; 2192; 2230) functioning as a gateway, comprises processing circuitry (1804; 1904; 2228), which is configured to execute the steps of embodiment 1 to 27.
49. The communication system (2100; 2200) of any one of embodiments 45 to 48, wherein:
   the processing circuitry (2218) of the host computer (1330; 1410) is configured to execute a host application (2212), thereby providing the user data; and
   the processing circuitry (1104; 1438) of the UE (200; 300; 1900; 2191; 2192; 2230) is configured to execute a client application (2232) associated with the host application (2212).

1. A method of handling a sidelink, SL, positioning procedure, the method comprising or initiating:
obtaining information indicative of a distortion of a radio link of at least one radio device among radio devices involved in the SL positioning procedure; and
performing one or more actions that handle the distortion based on the obtained information.

2. The method of claim 1, wherein the distortion is associated with a radio protocol event at the at least one radio device wherein the radio protocol event includes at least one of:
a handover, HO, of the at least one radio device;
a cell change of the at least one radio device;
a radio resource control, RRC, connection establishment or an RRC connection re-establishment of the indicated radio link;
an RRC configuration or an RRC reconfiguration of the indicated radio link;
the at least one radio device triggering a HO in the RRC connected mode;
a link quality of the indicated radio link being less than a predefined link quality threshold;
a RAN connection failure;
a radio link failure, RLF, of the indicated radio link;
a beam failure detection or beam failure recovery of the indicated radio link;
a 3GPP timer T310 is running;
a 3GPP timer T311 is running;
a 3GPP timer T301 is running; and
a 3GPP timer T304 is running.

3. The method of claim 1, wherein the obtaining of the information indicative of the distortion comprises detecting the distortion by the at least one radio device.

4. The method of claim 1, wherein the performing of the action comprises using a dedicated resource pool or an exceptional resource pool.

5. The method of claim 1, wherein the performing of the action comprises the at least one radio device using an SL resource allocation mode, wherein the at least one radio device autonomously selects SL resources from one or both of the one or multiple TX resource pools and the one or multiple RX resource pools, based on random selection using an exceptional pool of concerned SL frequency, to perform sidelink transmission and reception.

6. The method of claim 1, wherein one or both the distortion comprises a handover, HO, of the at least one radio device and the information indicative of the distortion comprises a handover command, and wherein the performing of the action comprises the at least one radio device performing one or both of a SL transmission and a SL reception based on a reception resource pool of a target cell of the HO or a reception resource pool of a target cell as provided in the handover command.

7. (canceled)

8. (canceled)

9. The method of claim 1, wherein performing the one or more actions comprises transmitting or receiving a HO command providing a SL positioning resource configuration to the at least one radio device and wherein among positioning resource pools configured in a target cell, there is at least one positioning resource pool which is dedicated for SL positioning purpose.

10. The method of claim 1, wherein the obtaining of the information indicative of the distortion comprises receiving a radio resource control, RRC, reconfiguration message for a reconfiguration with synchronization, the reconfiguration configuring the at least one radio device with a SL positioning reference signal, PRS, reception pool.

11. The method of claim 1, wherein the method is performed by at least one of:
a network node serving the at least one radio device;
the target radio device;
the one or more assisting radio devices; and
a positioning server optionally a location management function, LMF.

12. The method of claim 11, wherein the target radio device does not select a radio device which is experiencing at least one of RLF, RRC reestablishment and handover as assisting radio device.

13.-24. (canceled)

25. The method of claim 1, wherein the performing of the action comprises determining whether the at least one radio device optionally one or more assisting radio devices is kept or replaced in the SL positioning procedure.

26.-32. (canceled)

33. A network node configured to:
obtain information indicative of a distortion of a radio link of at least one radio device among radio devices involved in a SL positioning procedure; and
perform one or more actions that handle the distortion based on the obtained information.

34. The network node of claim 33, wherein the distortion is associated with a radio protocol event at the at least one radio device, wherein the radio protocol event includes at least one of:
a handover, HO, of the at least one radio device;
a cell change of the at least one radio device;
a radio resource control, RRC, connection establishment or an RRC connection re-establishment of the indicated radio link;
an RRC configuration or an RRC reconfiguration of the indicated radio link;
the at least one radio device triggering a HO in the RRC connected mode;
a link quality of the indicated radio link being less than a predefined link quality threshold;
a RAN connection failure;
a radio link failure, RLF, of the indicated radio link;
a beam failure detection or beam failure recovery of the indicated radio link;
a 3GPP timer T310 is running;
a 3GPP timer T311 is running:
a 3GPP timer T301 is running; and
a 3GPP timer T304 is running.

35. (canceled)

36. (canceled)

37. A target radio device configured to:
obtain information indicative of a distortion of a radio link of at least one radio device among radio devices involved in a SL positioning procedure; and
perform one or more actions that handle the distortion based on the obtained information.

38. The target radio device of claim 37, wherein the distortion is associated with a radio protocol event at the at least one radio device, wherein the radio protocol event includes at least one of:
a handover, HO, of the at least one radio device;
a cell change of the at least one radio device;
a radio resource control, RRC, connection establishment or an RRC connection re-establishment of the indicated radio link;
an RRC configuration or an RRC reconfiguration of the indicated radio link;
the at least one radio device triggering a HO in the RRC connected mode;
a link quality of the indicated radio link being less than a predefined link quality threshold;
a RAN connection failure;
a radio link failure, RLF, of the indicated radio link;
a beam failure detection or beam failure recovery of the indicated radio link;
a 3GPP timer T310 is running;
a 3GPP timer T311 is running;
a 3GPP timer T301 is running; and
a 3GPP timer T304 is running.

39.-46. (canceled)

47. The of claim 3, wherein the performing of the action comprises using a dedicated resource pool or an exceptional resource pool.

48. The of claim 3, wherein the performing of the action comprises the at least one radio device using an SL resource allocation mode, wherein the at least one radio device autonomously selects SL resources from one or both of the one or multiple TX resource pools and the one or multiple RX resource pools, based on random selection using an exceptional pool of concerned SL frequency, to perform sidelink transmission and reception.

49. The of claim 3, wherein one or both the distortion comprises a handover, HO, of the at least one radio device and the information indicative of the distortion comprises a handover command, and wherein the performing of the action comprises the at least one radio device performing one or both of a SL transmission and a SL reception based on a reception resource pool of a target cell of the HO or a reception resource pool of a target cell as provided in the handover command.

50. The of claim 3, wherein performing the one or more actions comprises transmitting or receiving a HO command providing a SL positioning resource configuration to the at least one radio device, and wherein among positioning resource pools configured in a target cell, there is at least one positioning resource pool which is dedicated for SL positioning purpose.

51. The of claim 3, wherein the obtaining of the information indicative of the distortion comprises receiving a radio resource control, RRC, reconfiguration message for a reconfiguration with synchronization, the reconfiguration configuring the at least one radio device with a SL positioning reference signal, PRS, reception pool.
